(19) United States
(12) Patent Application Publication
(10) Pub. No.: US 2011/0032452 A1
(43) Pub. Date: Feb. 10, 2011

(54) LIGHTING DEVICE, DISPLAY DEVICE AND TELEVISION RECEIVER

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/988,655

(22) PCT Filed: Mar. 19, 2009
(86) PCT No.: PCT/JP2009/055442

§ 371 Date: Oct. 20, 2010

(30) Foreign Application Priority Data
Apr. 28, 2008 (JP) 2008-117709

(51) Int. Cl. G02F 1/13357; F21V 7/00; F21V 13/10; F21V 29/00

(52) U.S. Cl. 349/62; 362/296.01; 362/307; 362/298; 362/294; 362/235

(57) ABSTRACT

A lighting device 12 of the present invention includes a light source 17, a chassis 14 housing the light source 17 and having an opening 14b for light from the light source 17 to pass through, and an optical member 15a provided so as to face the light source 17 and cover the opening 14b. The optical member 15a is formed of a member having a substantially uniform light reflectance, and has a first surface 30a facing the light source 17 and a second surface 30b opposite from the first surface 30a. A light reflecting portion 31 is formed on a portion of the second surface 30b that overlaps the light source 17. The light reflecting portion 31 reflects light from the first surface 30a. A light scattering portion 32 is formed on a portion of the optical member 15a that does not overlap the light source 17. The light scattering portion 32 scatters the light.

### TECHNICAL FIELD

The present invention relates to a lighting device, a display device and a television receiver.

### BACKGROUND ART

A liquid crystal panel included in a liquid crystal display device does not emit light, and thus a backlight device is required as a separate lighting device. The backlight device is arranged behind the liquid crystal panel (i.e., on a side opposite from a display surface side). It includes a chassis having an opening on a liquid crystal panel side, a plurality of fluorescent tubes accommodated in the chassis as light sources, and a diffuser plate and the like provided at the opening of the chassis for efficiently directing light emitted from the fluorescent tubes to a liquid crystal panel.

In such a backlight device where the fluorescent tubes emit linear light, a plurality of fluorescent tubes are aligned with each other and the optical member converts linear light into planer light to unify illumination light. However, if the linear light is not sufficiently converted into the planer light, striped lamp images are generated along the alignment of the fluorescent tubes, and this deteriorates display quality of the liquid crystal display device.

To obtain uniform illumination light from the backlight device, it is desirable to increase the number of lamps and reduce a distance between the adjacent lamps or to increase a diffusion rate of a diffuser plate, for example. However, increase of the number of lamps increases a cost of the backlight device and also increases power consumption. Increase of the diffusion rate of the diffuser plate fails to improve luminance and causes the problem that the number of lamps is required to be increased. A backlight device disclosed in Patent Document 1 has been known as one that suppresses power consumption and ensures uniform luminance.

The backlight device described in Patent Document 1 includes a diffuser plate provided on a light output side of a plurality of cold cathode tubes. A dimming dot pattern having a light transmission rate (opening rate) from 62 to 71% and haze from 90 to 99% is printed on the light diffuser plate. A dot diameter of each dot is varied from 0.16 mm to 0.7 mm depending on a distance from the cold cathode tubes. According to such a configuration, the light source can emit a light having sufficient luminance and uniform luminance without increasing power consumption of the light source.

[Patent Document 1] Japanese Unexamined Patent Publication No. 2005-117023

### Problem to be Solved by the Invention

In the configuration disclosed in Patent Document 1, the light transmission rate is controlled by changing a size (area) of each dot formed of a material containing a shielding agent and a diffusing agent. That is, the light is less likely to pass through the diffuser plate at a position immediately above the light source and the light easily passes through the diffuser plate at a position except for the position immediately above the light source. Therefore, further improvement is required to effectively use light emitted from the light source, especially light reflecting off the diffuser plate. Since the dimming dot pattern is generated on the diffuser plate, the synergetic effect of the diffusing effect of the diffuser plate and the dimming effect of the dot pattern is unlikely to be definite and this makes a design of the dot pattern to be complicated and difficult.

### DISCLOSURE OF THE PRESENT INVENTION

The present invention was made in view of the foregoing circumstances. An object of the present invention is to provide a lighting device in which light emitted from a light source is effectively used to ensure uniform brightness and achieve a cost reduction and power saving. Another object of the present invention is to provide a display device including such a lighting device and a television receiver including such a display device.

### Means for Solving the Problem

To solve the above problem, a lighting device of the present invention includes at least one light source, a chassis housing the light source and having an opening for light from the light source to pass through, an optical member provided so as to face the light source and cover the opening, and a light reflecting portion formed on a portion of the optical member that overlaps the light source. The optical member is formed of a member having a substantially uniform light reflectance. The light reflecting portion reflects light from the light source.

According to such a configuration, on the optical member provided at the opening of the chassis, the light reflecting portion is formed in the portion that overlaps the light source, that is, the portion that the light emitted from the light source easily reaches. Therefore, most of the light emitted from the light source reflects off the light reflecting portion (does not pass thorough the light reflecting portion), and the brightness of illumination light is suppressed with respect to the light emission amount from the light source. This suppresses brightness nonuniformity in the portion overlapping the light source and uniform illumination brightness can be obtained.

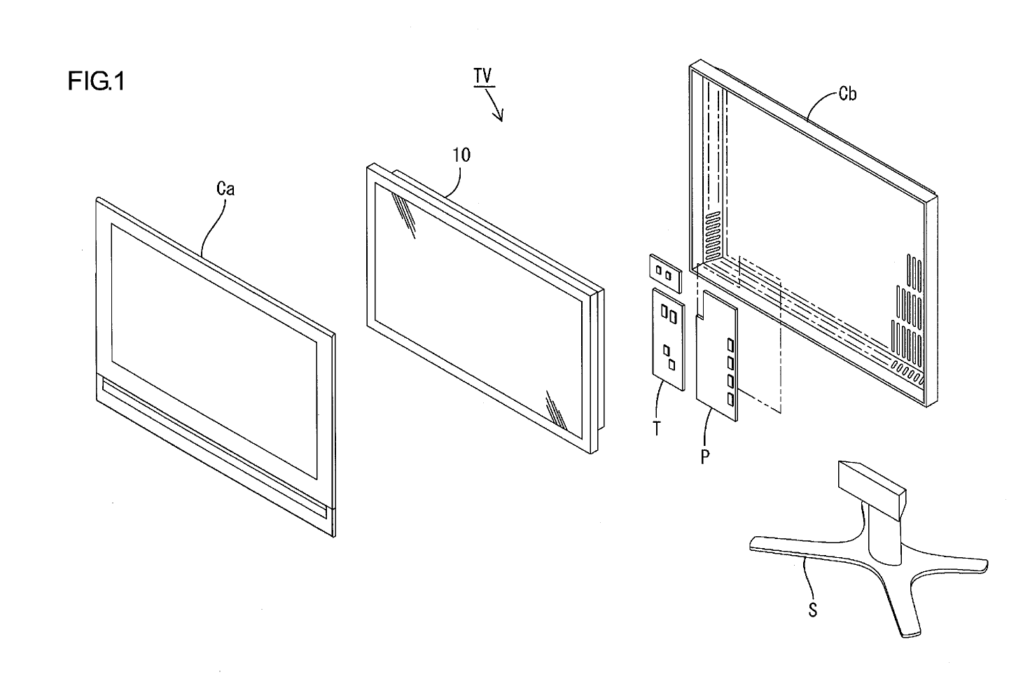

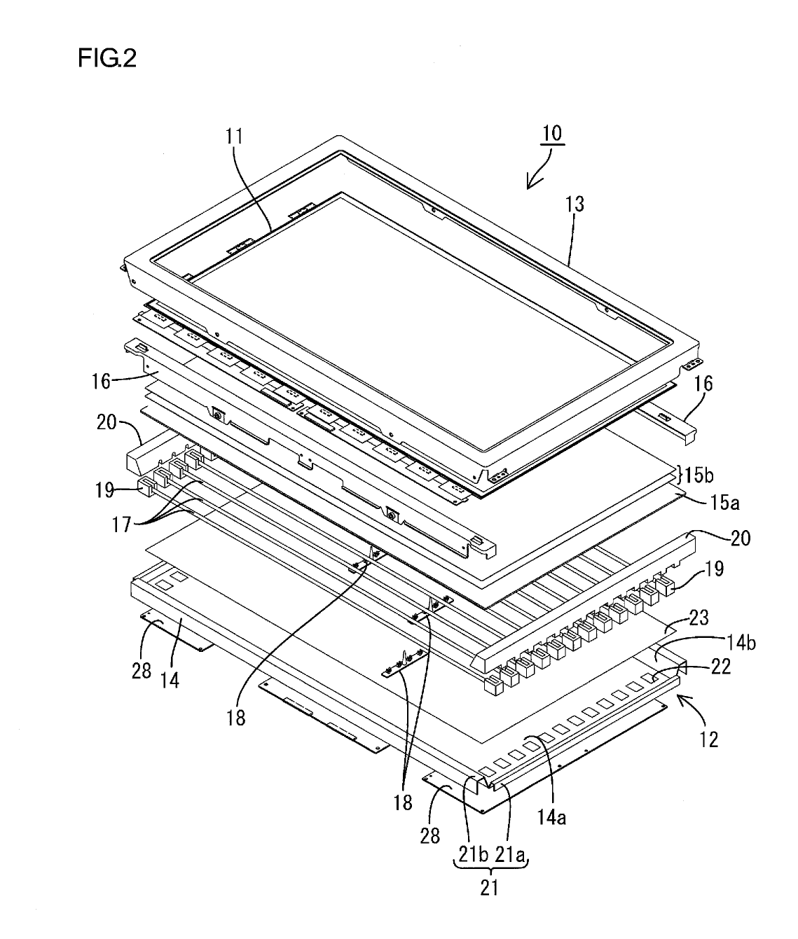

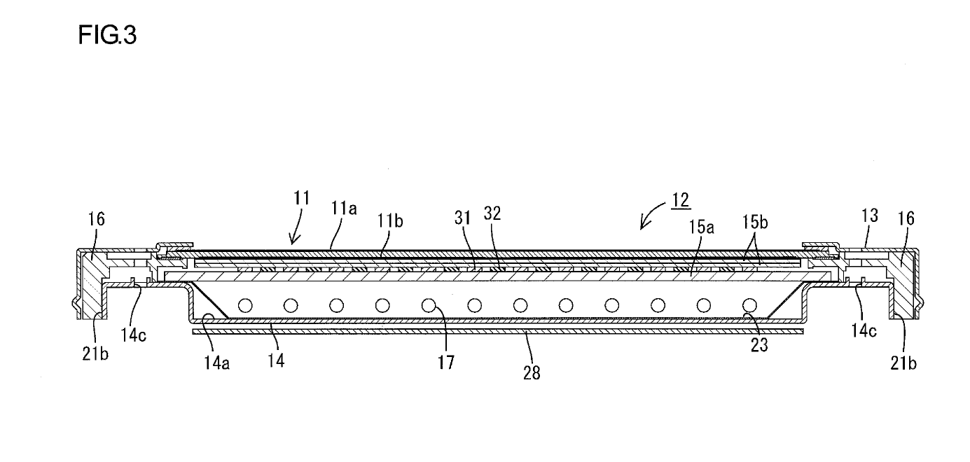

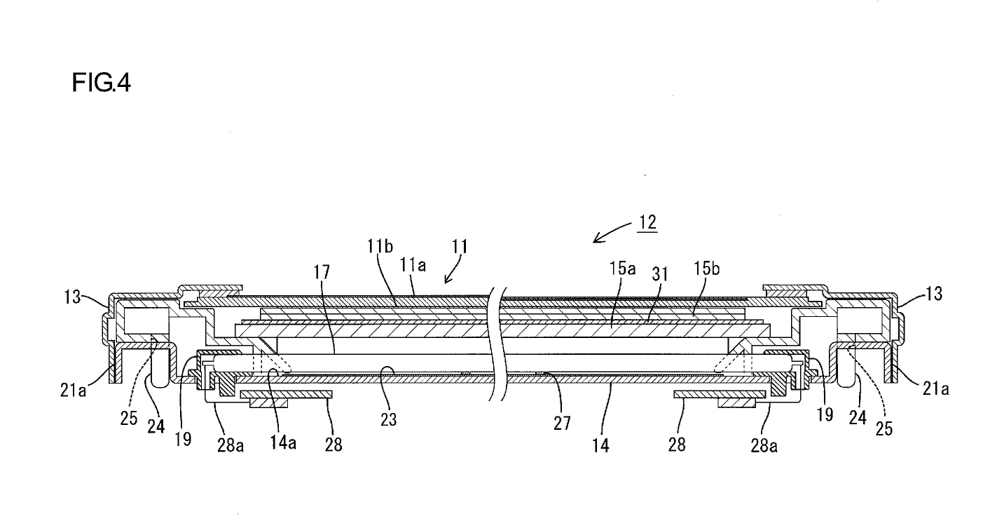

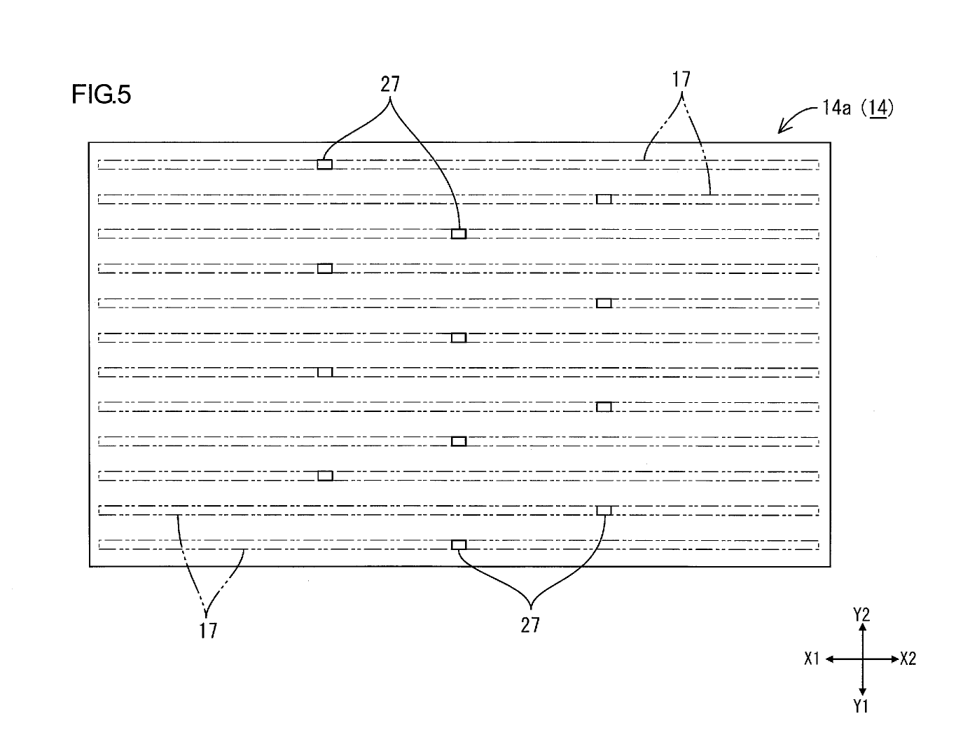

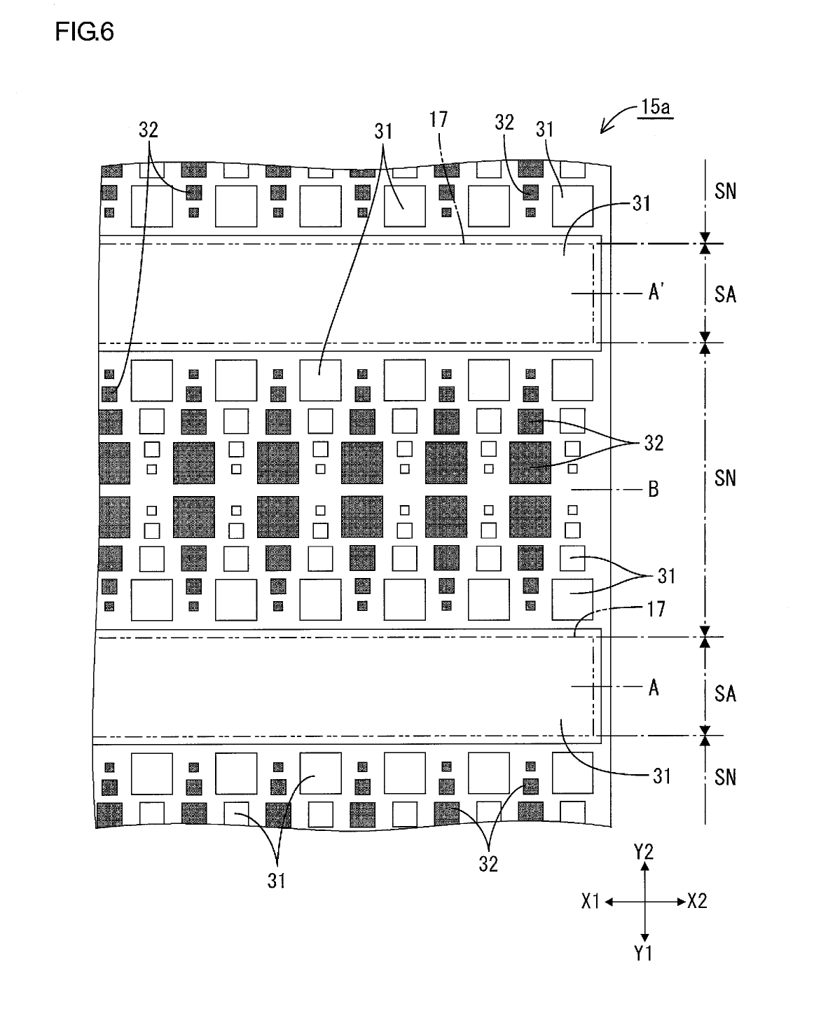

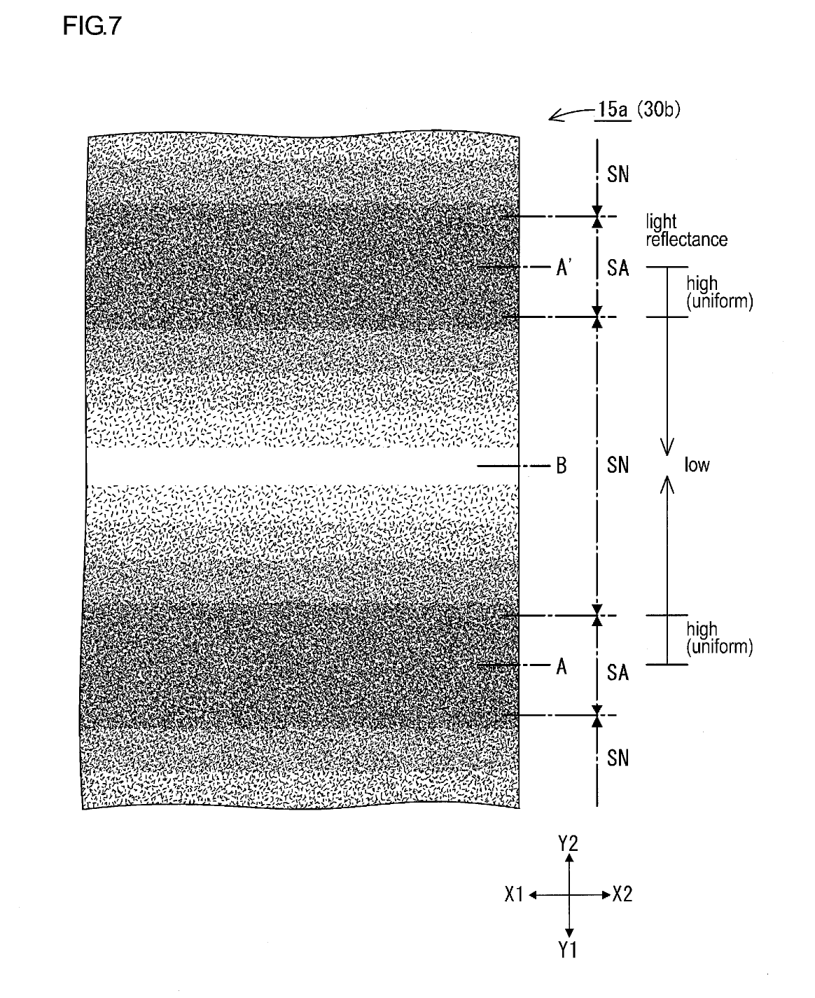

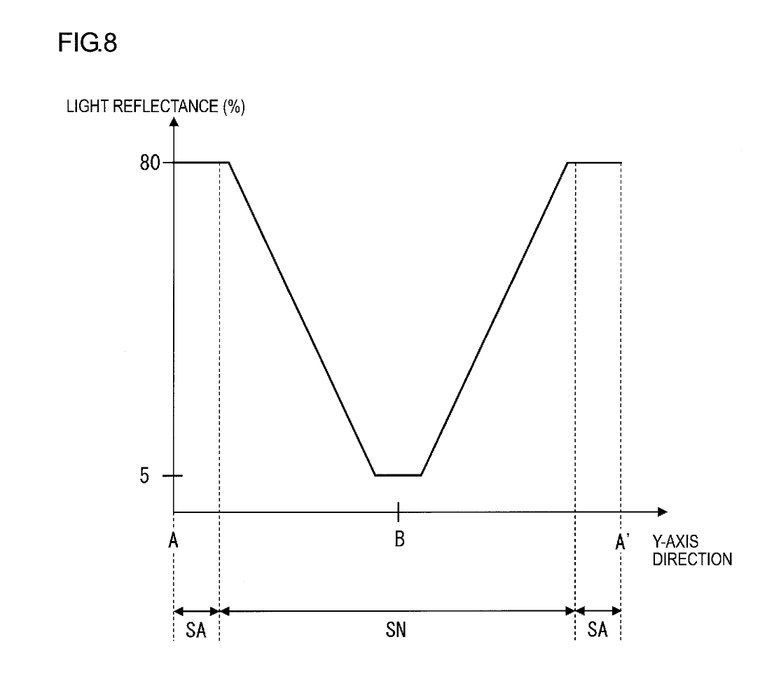

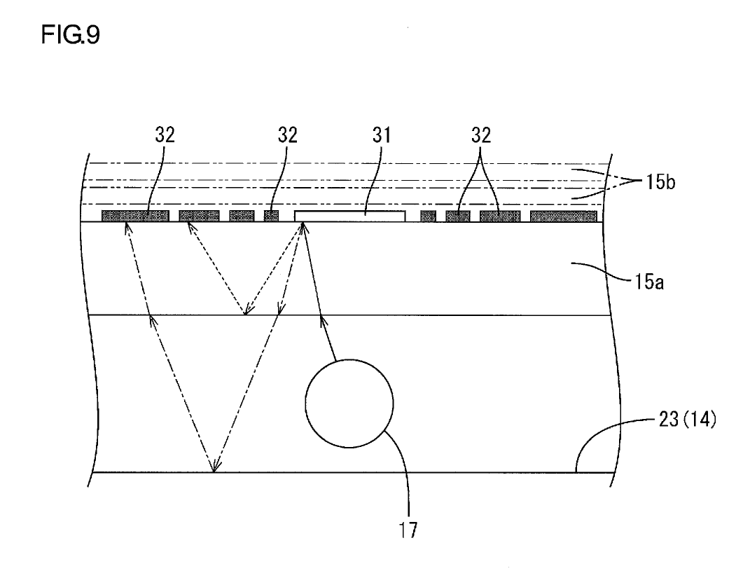

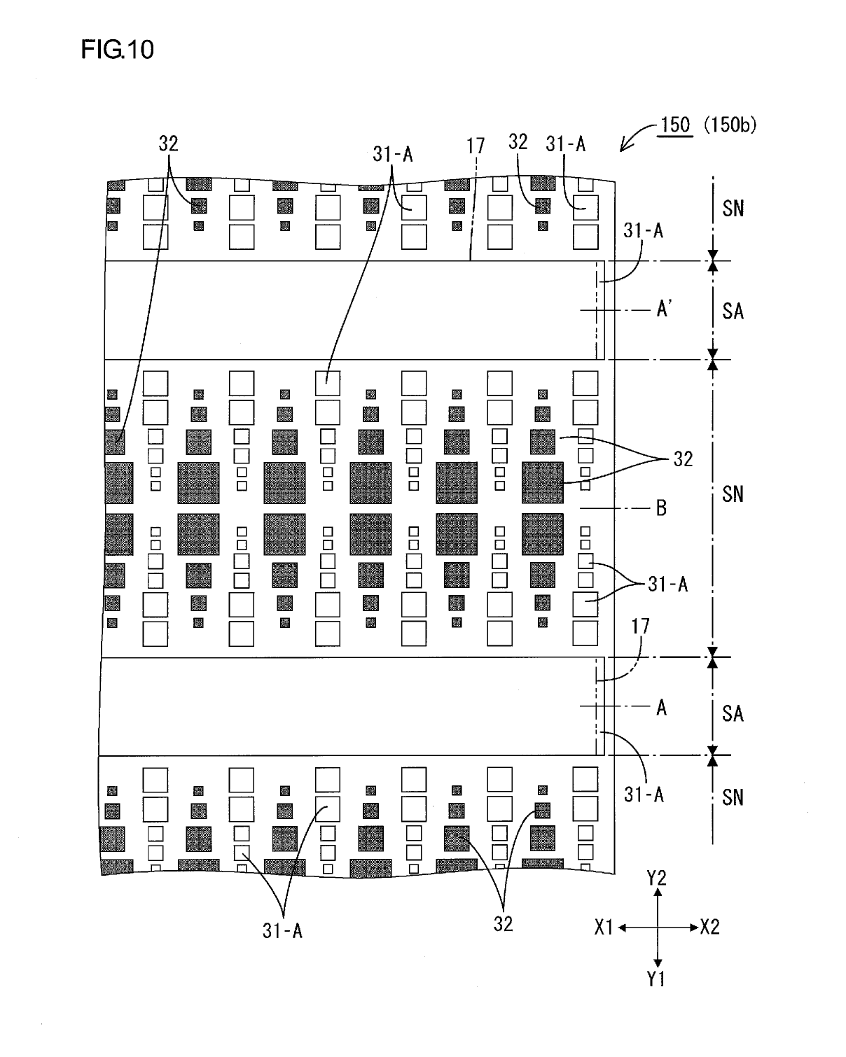

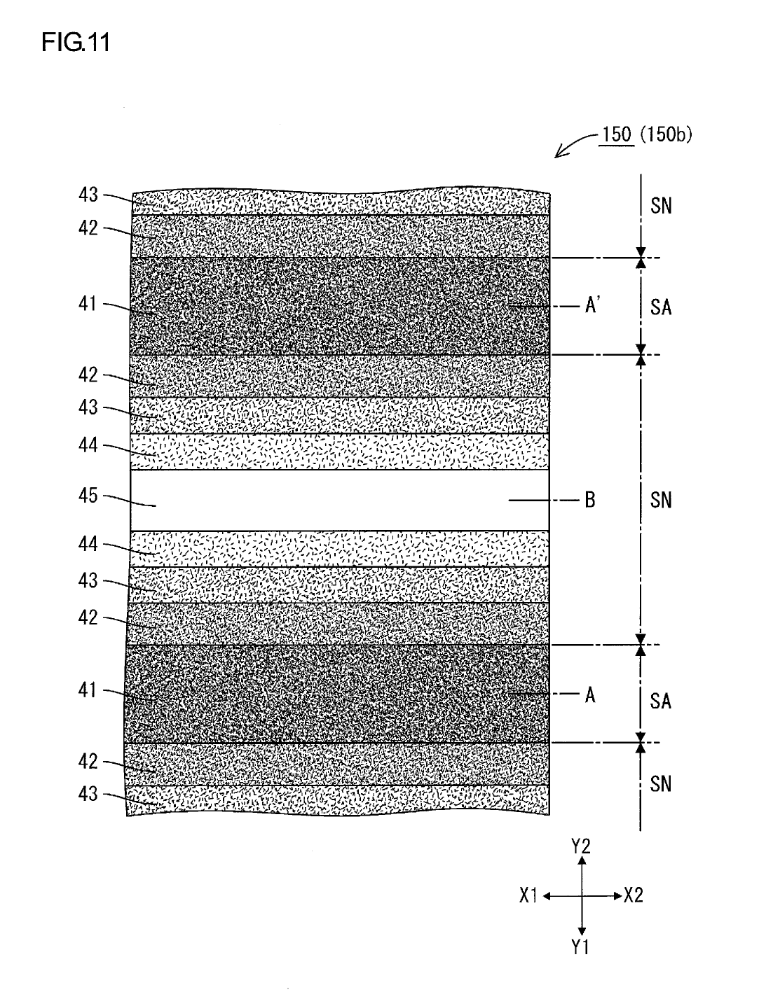

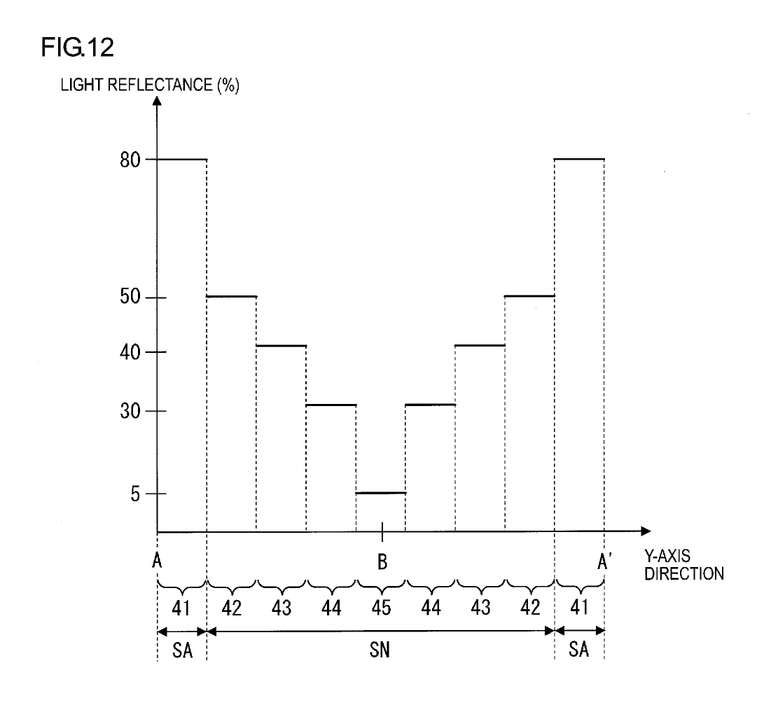

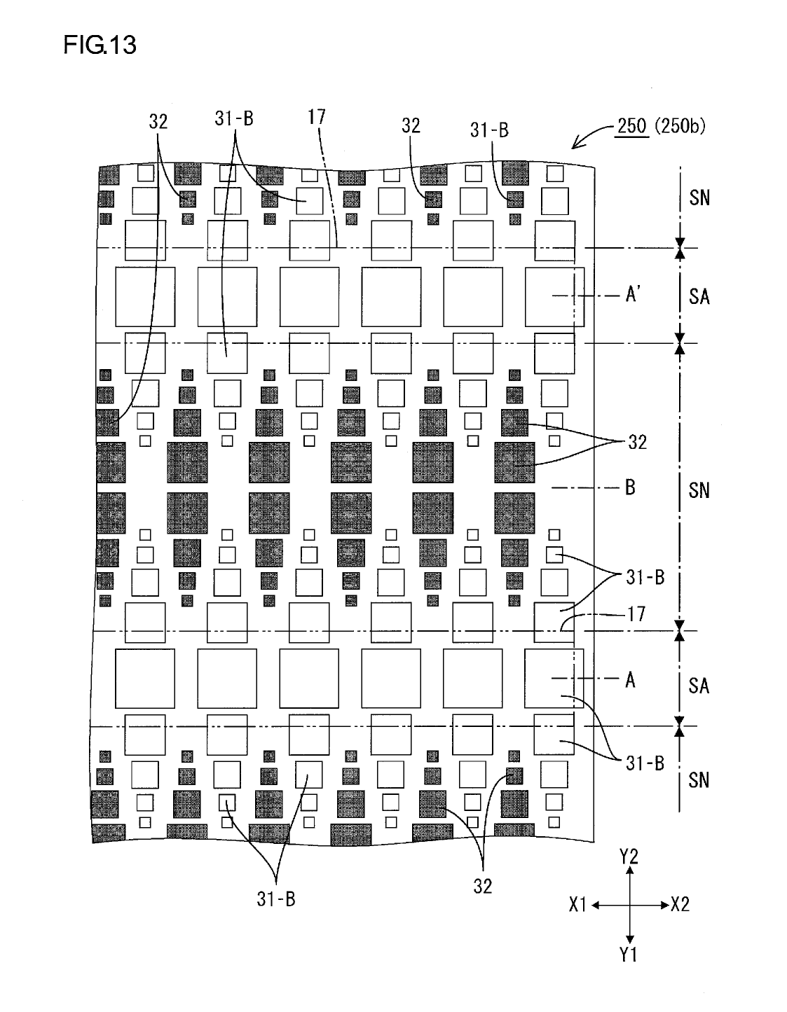

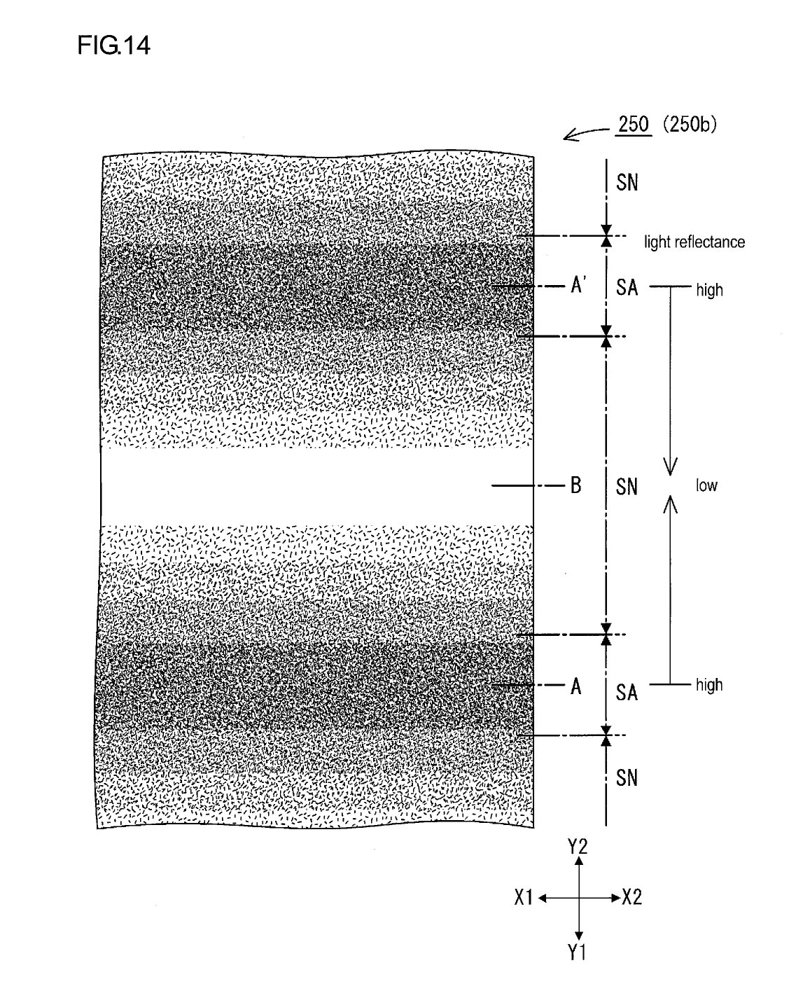

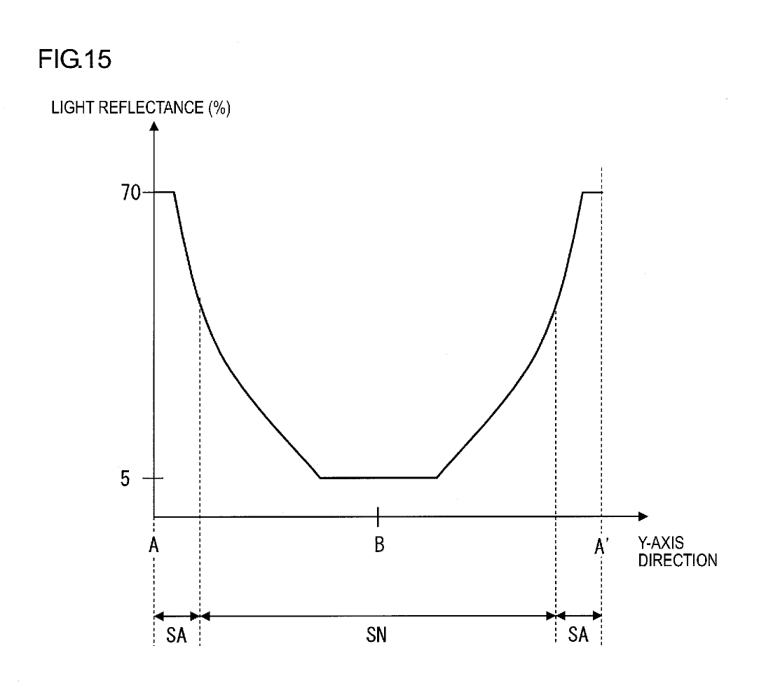

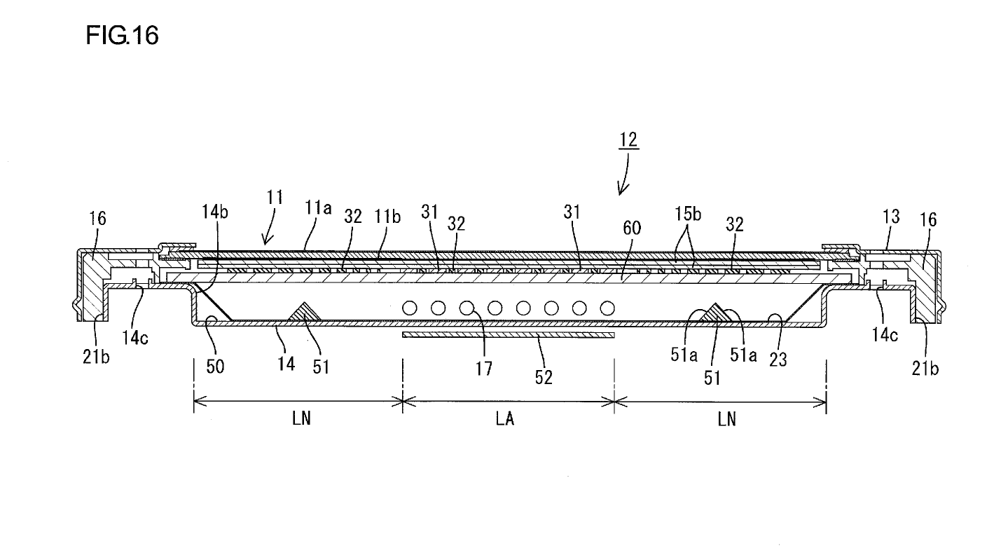

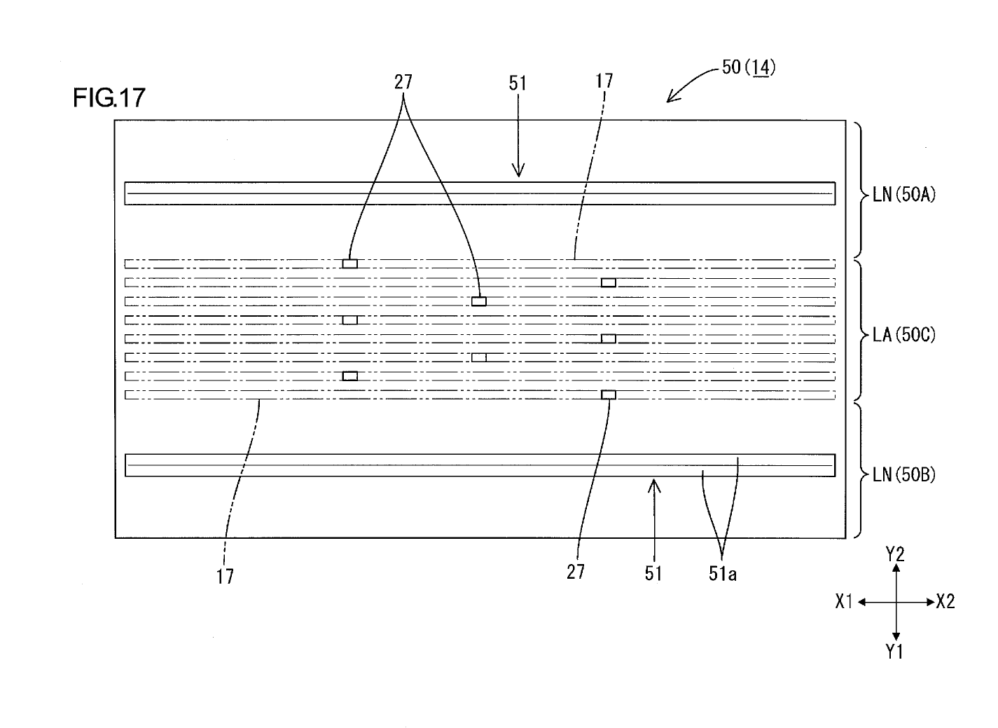

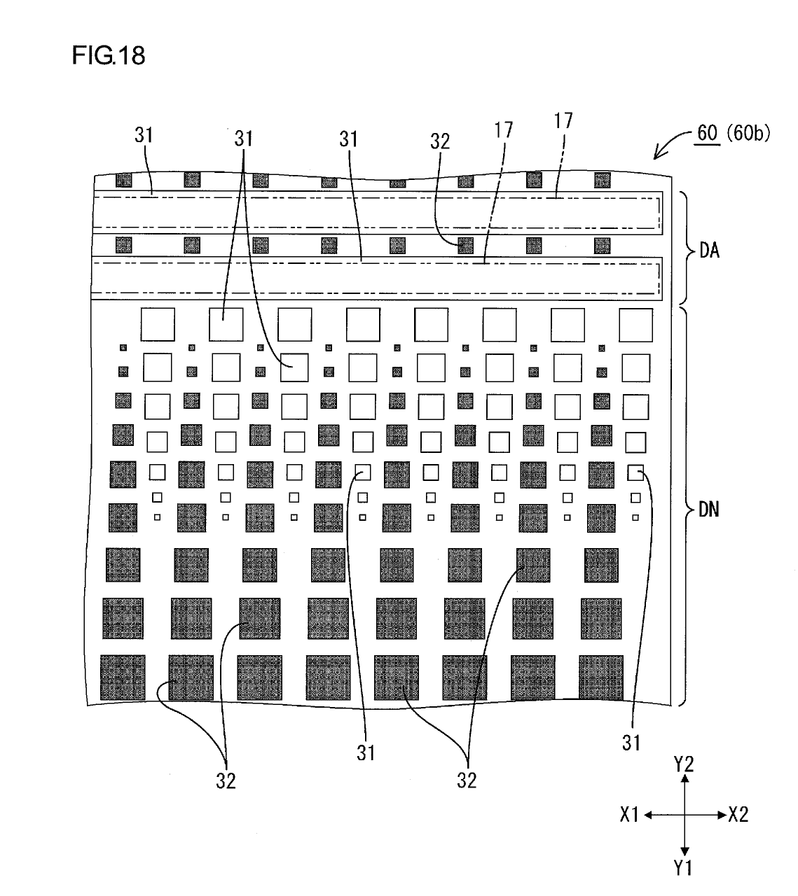

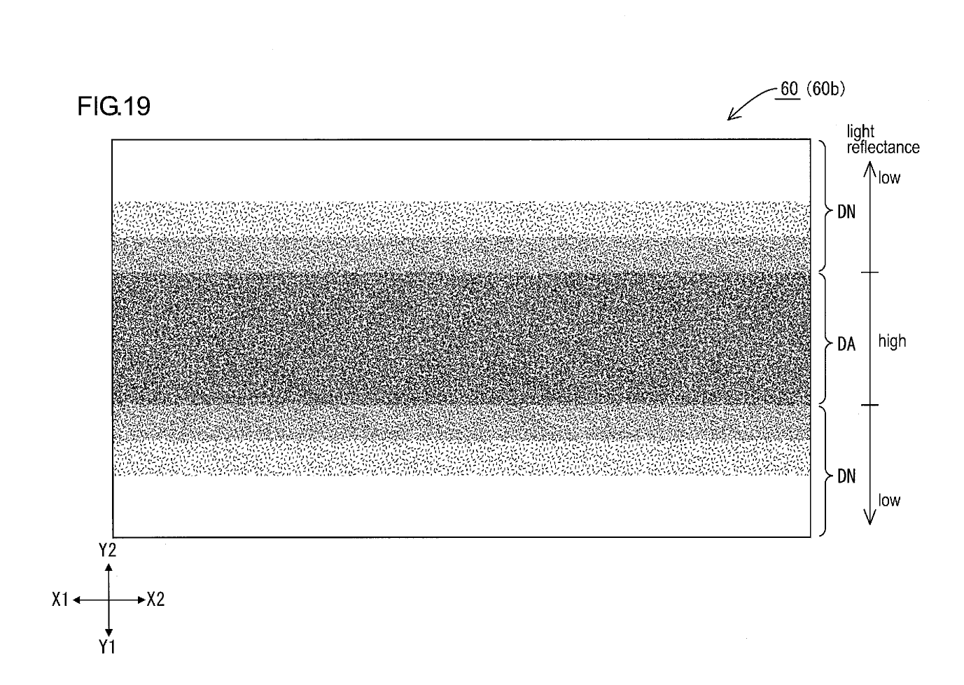

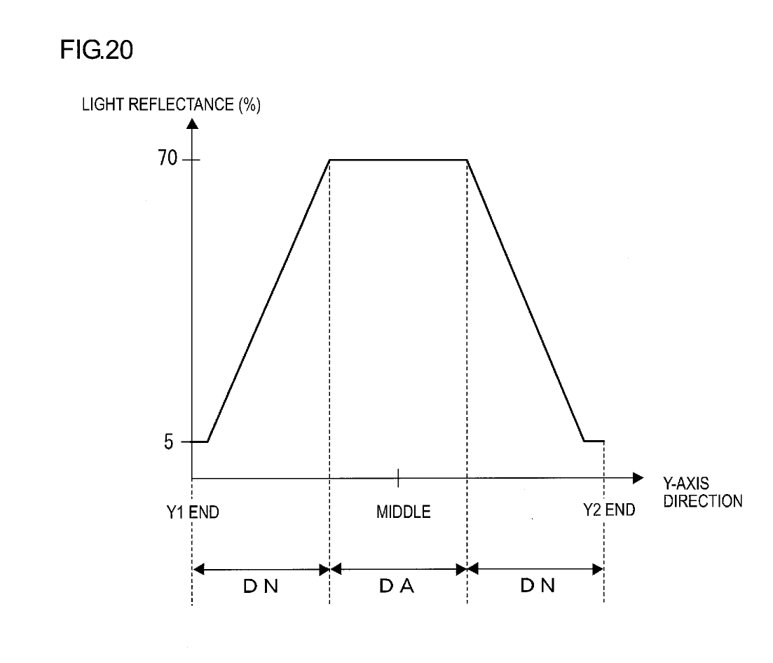

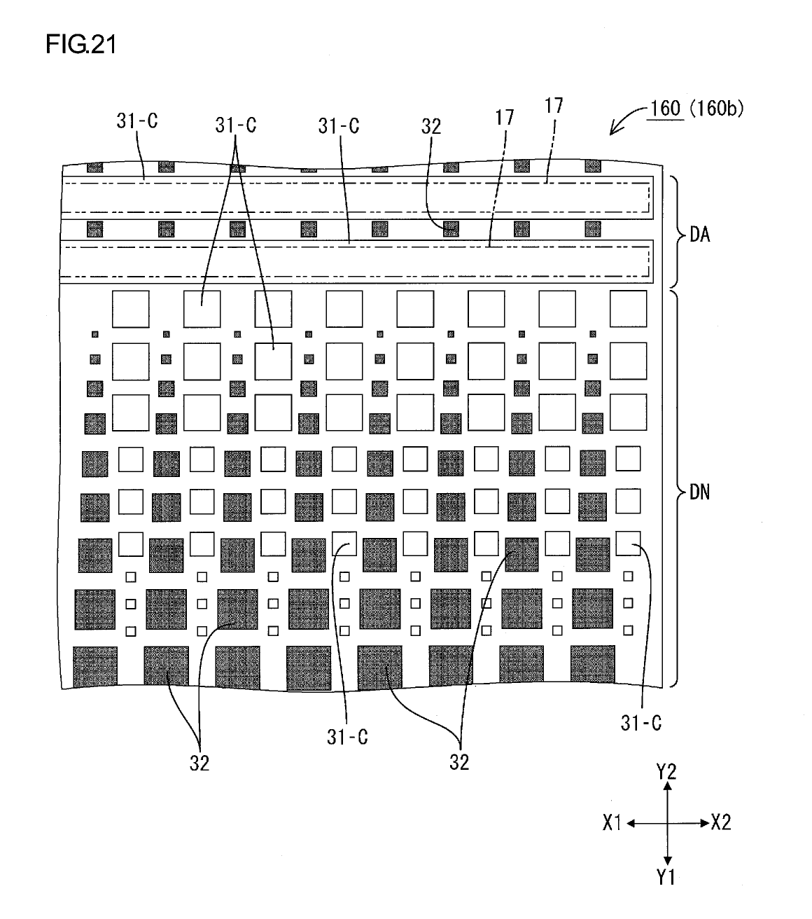

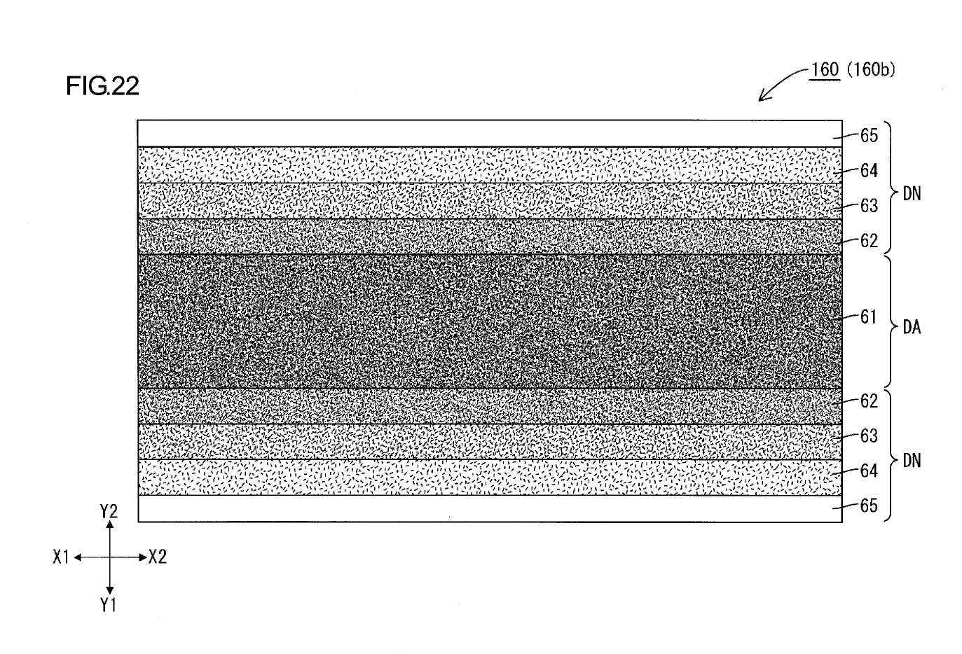

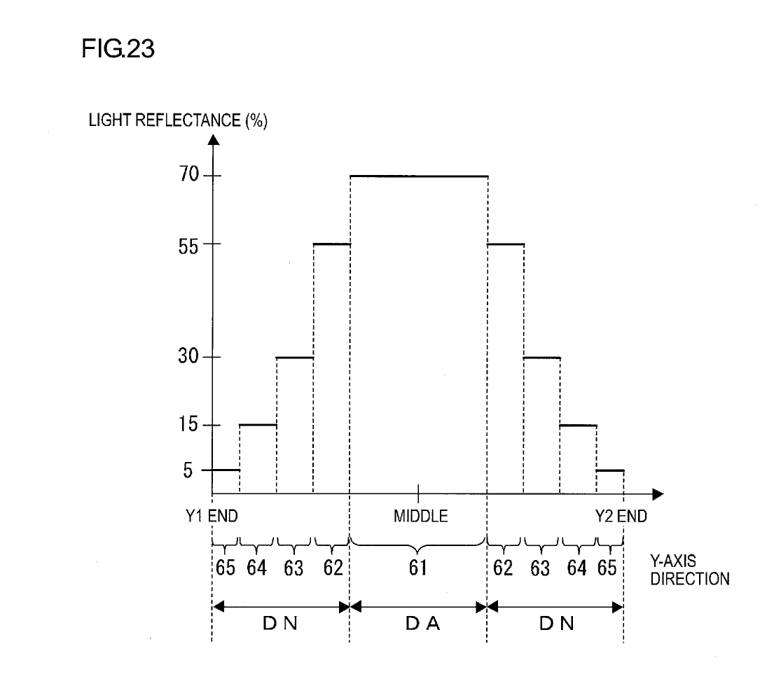

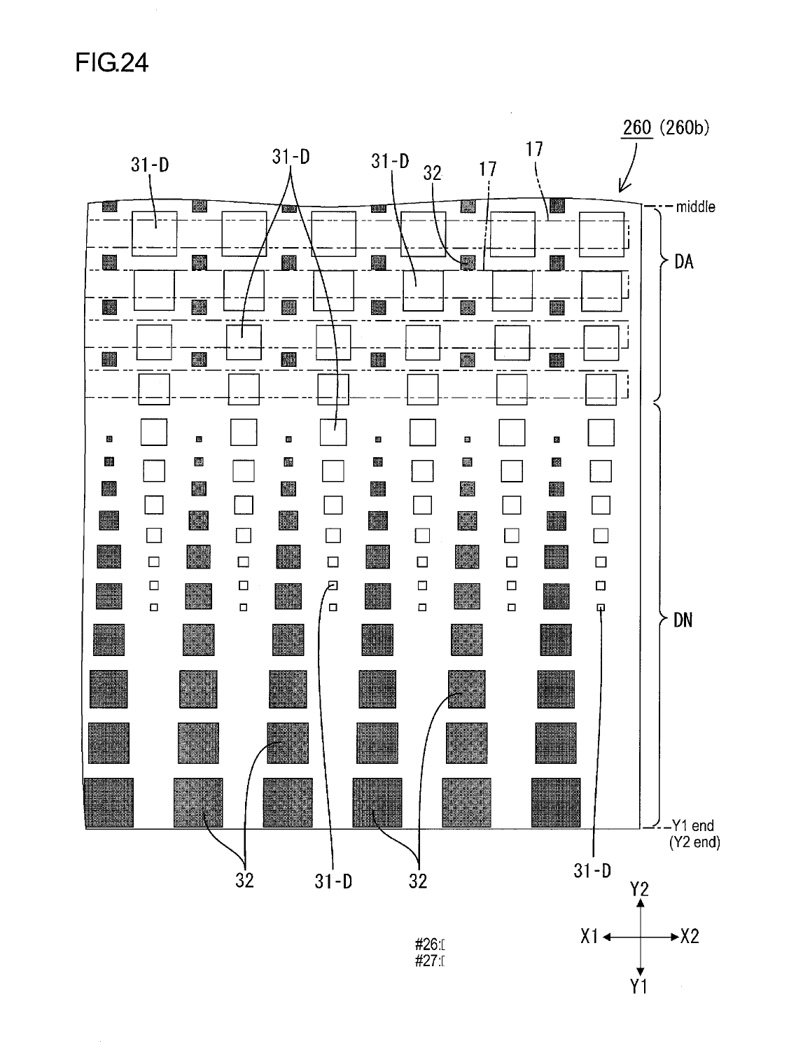

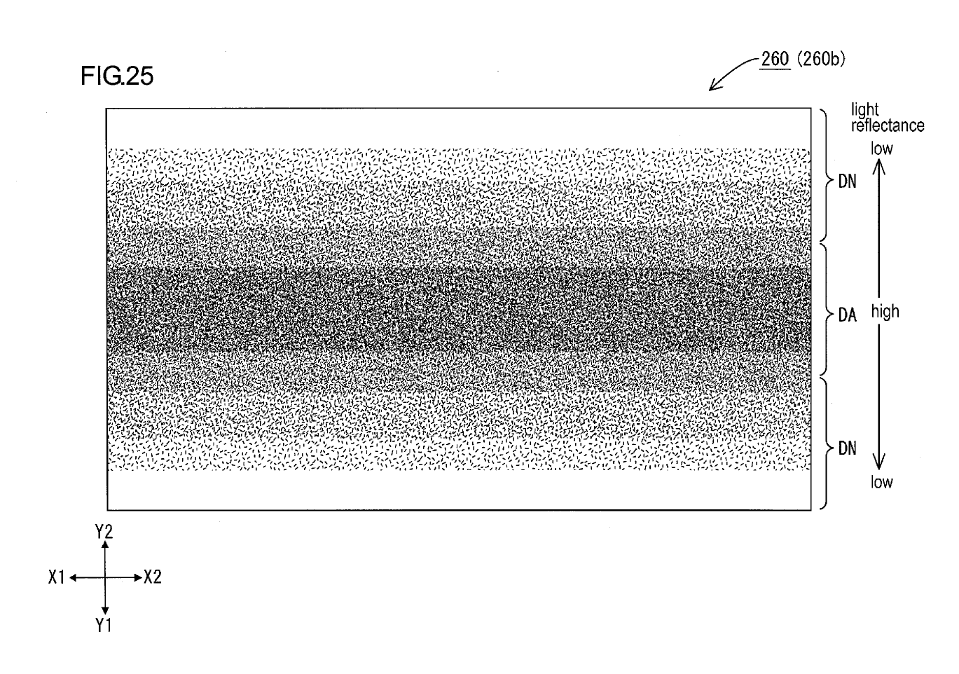

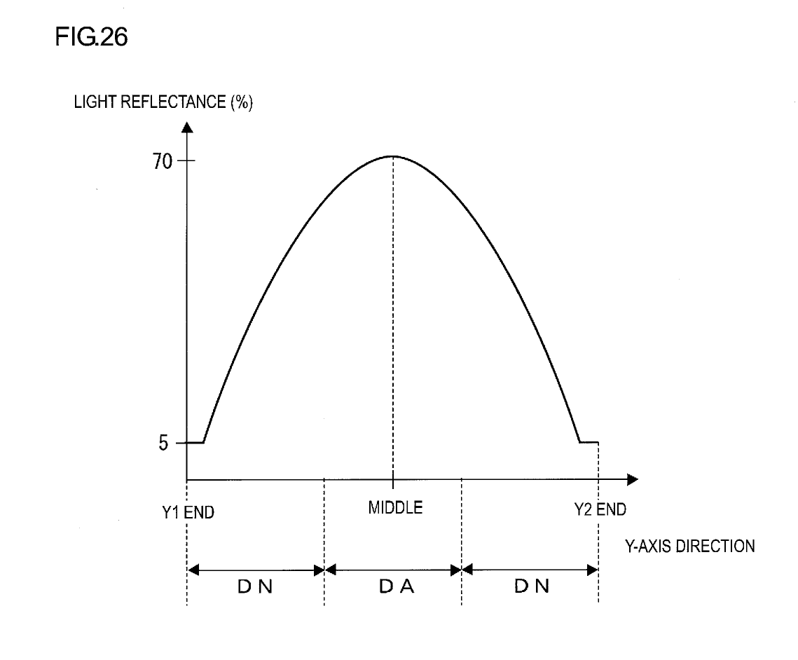

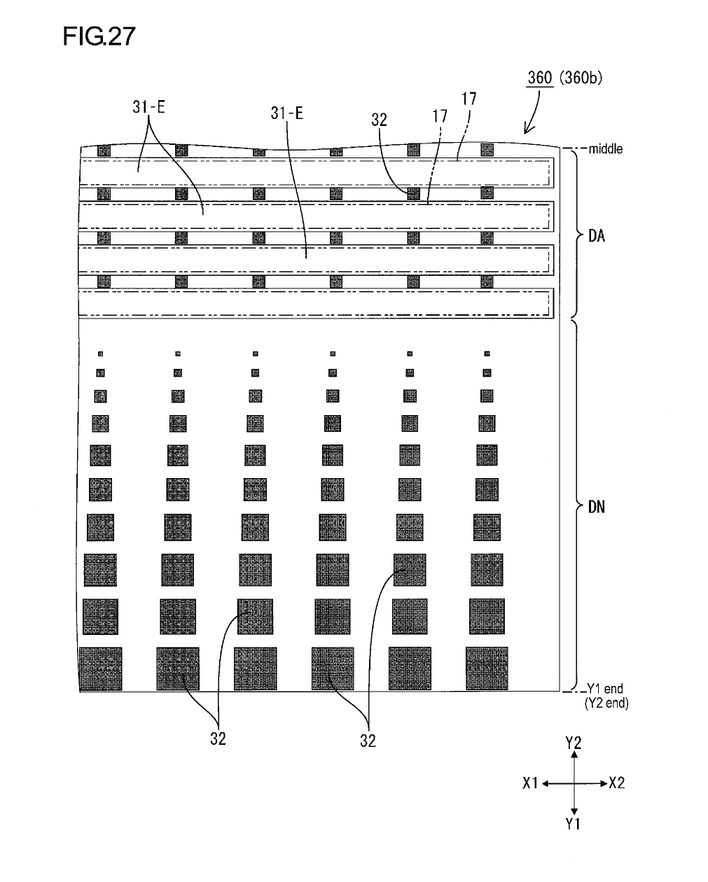

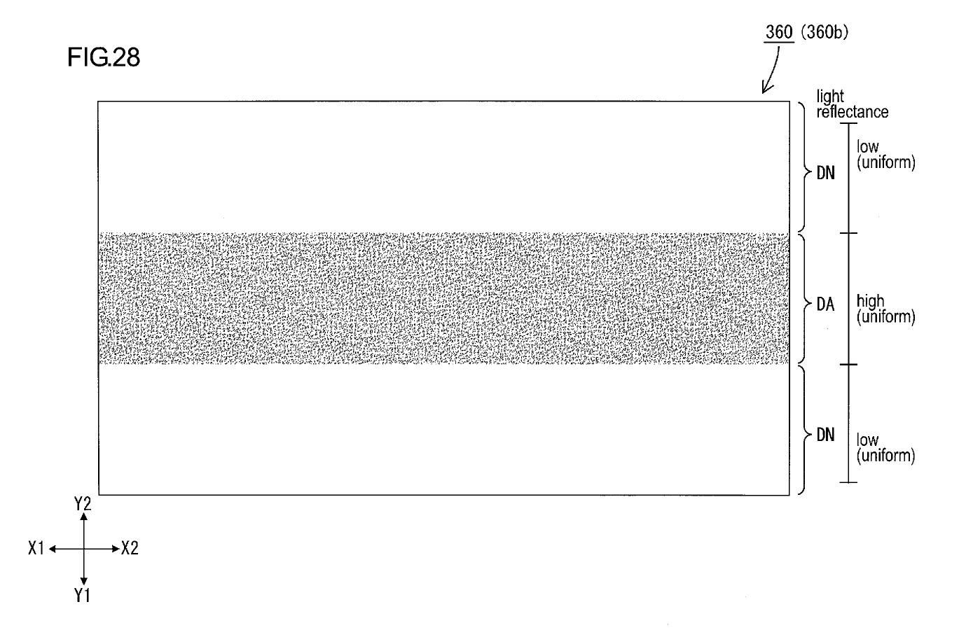

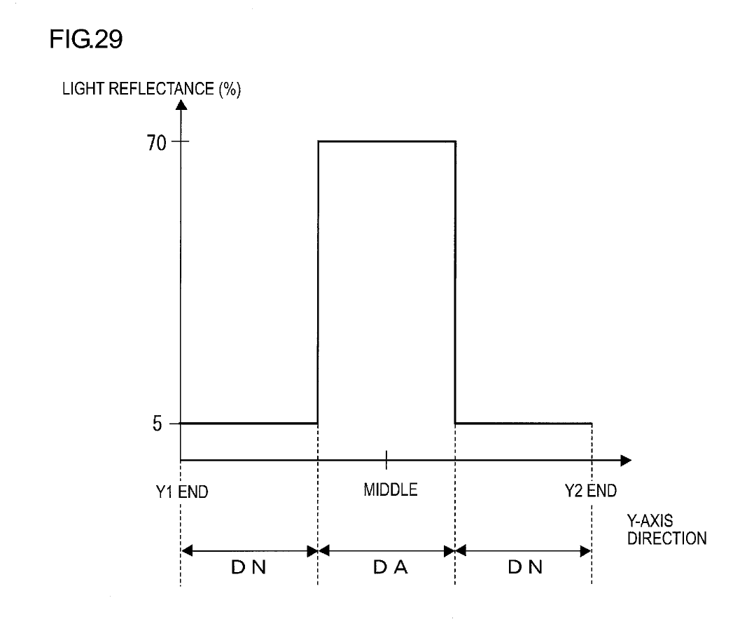

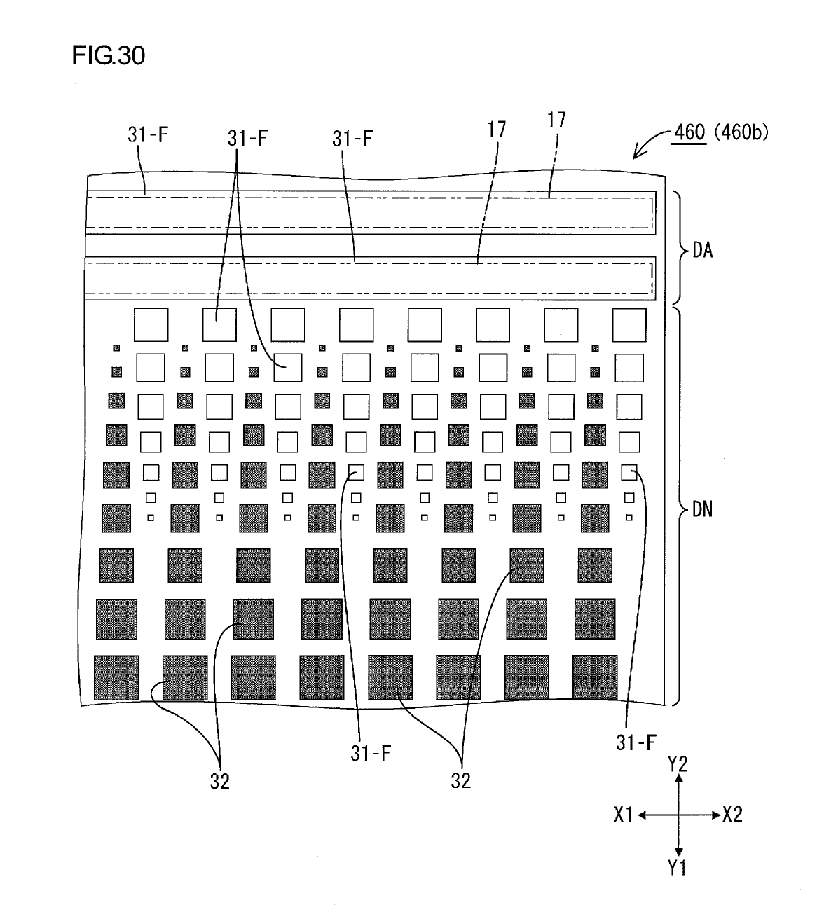

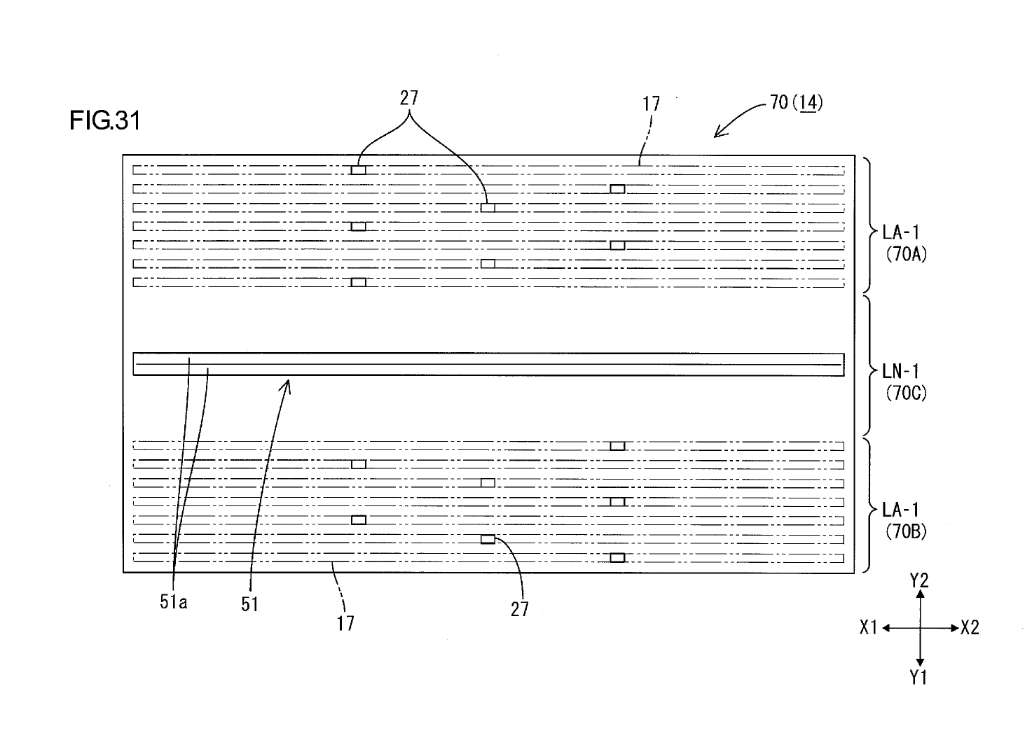

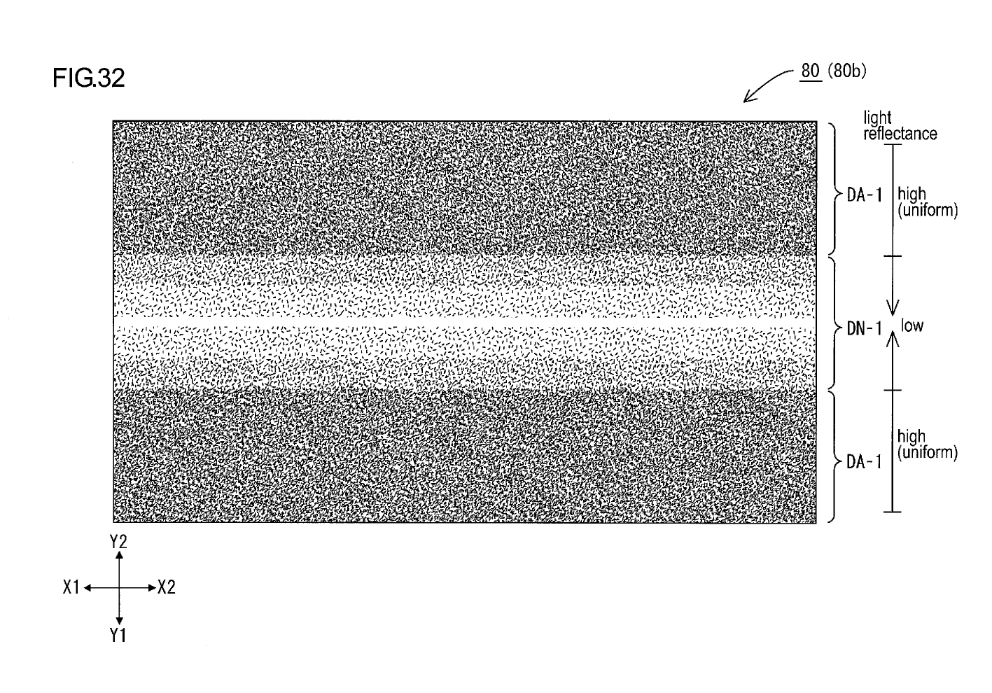

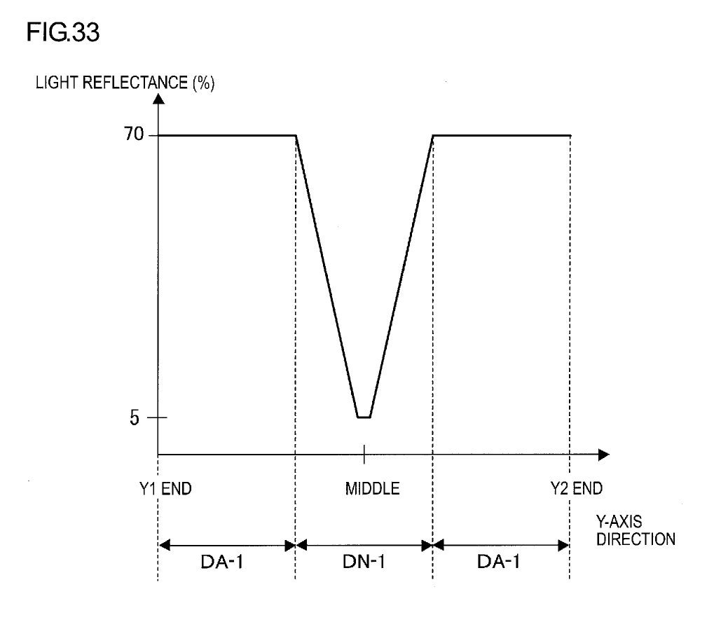

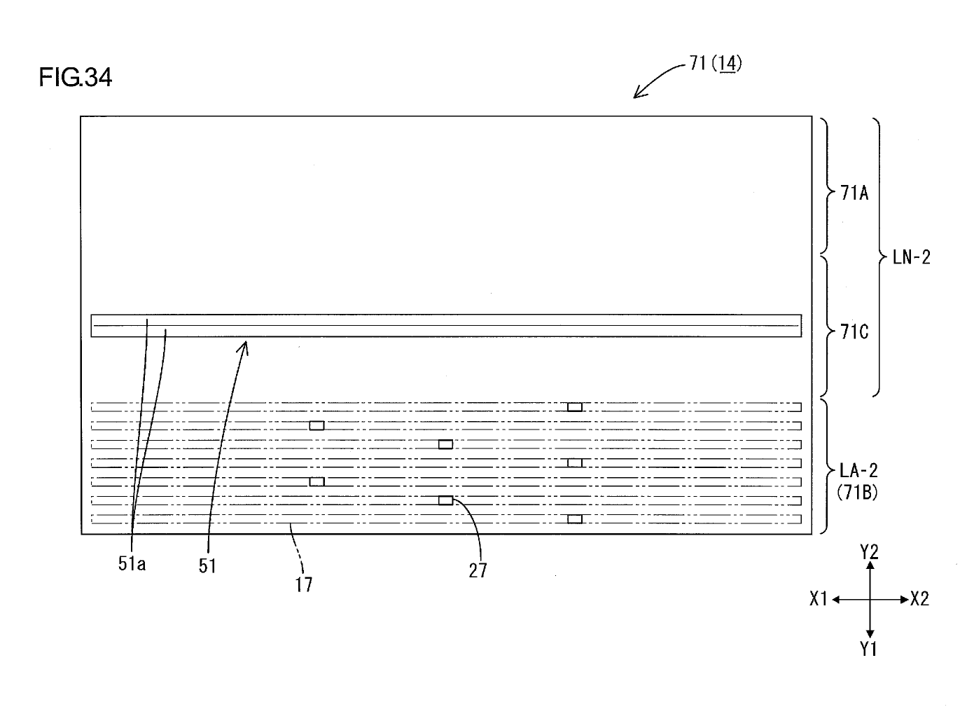

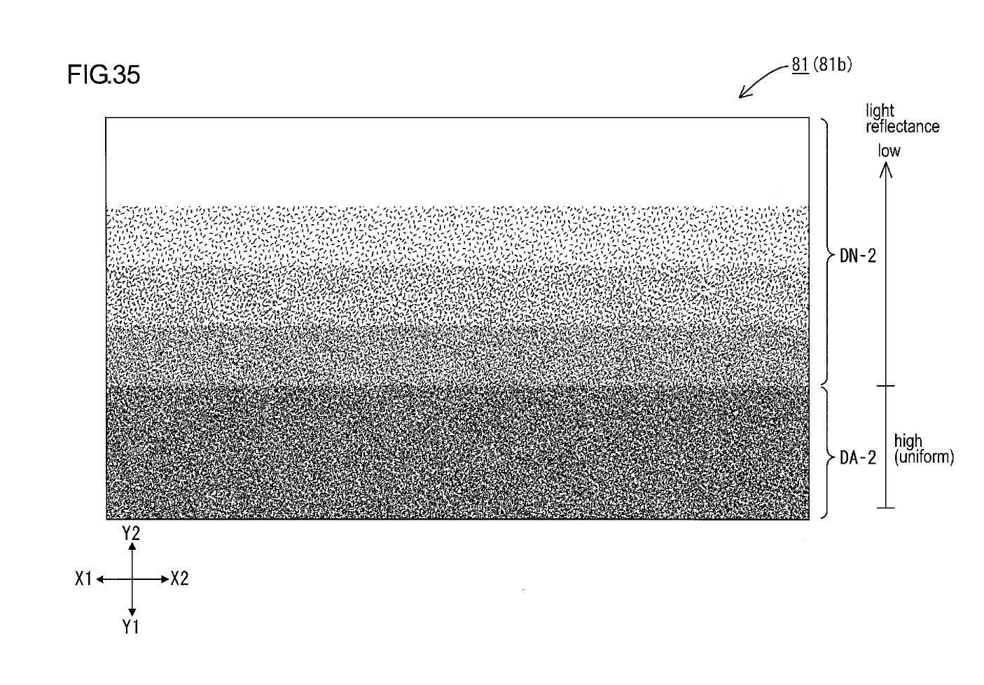

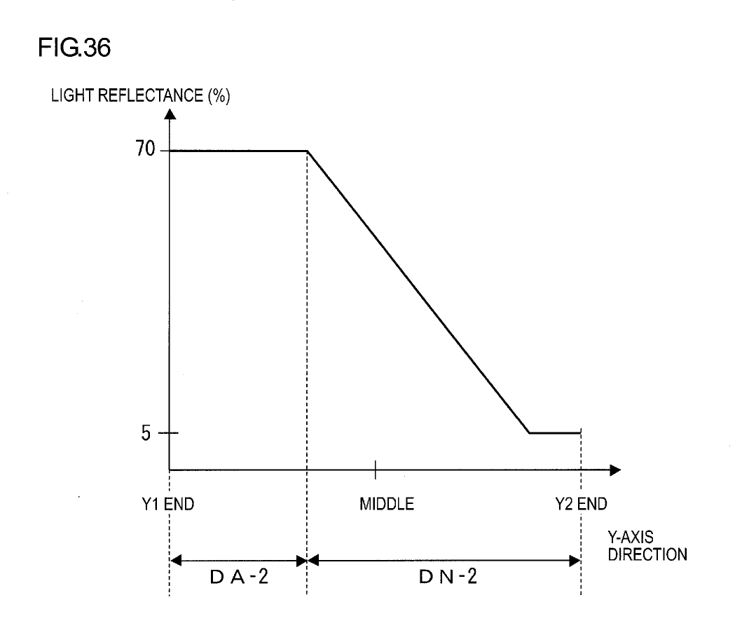

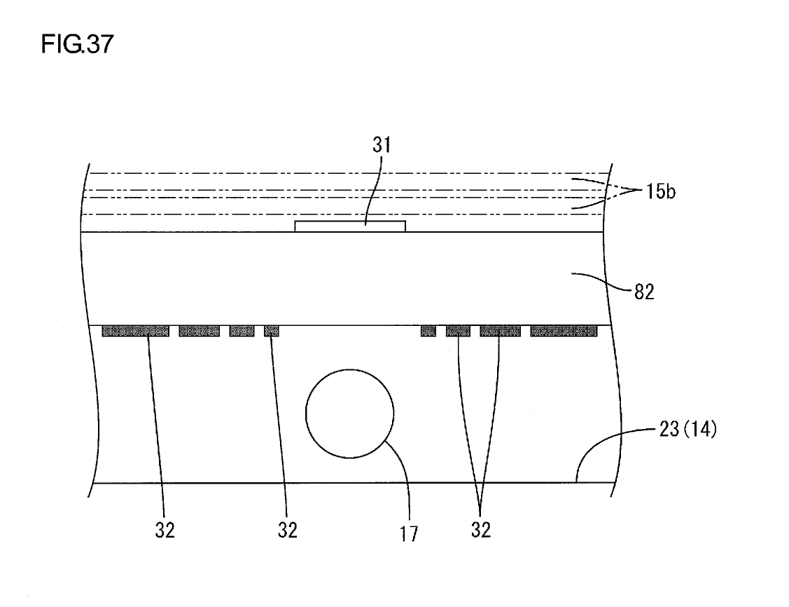

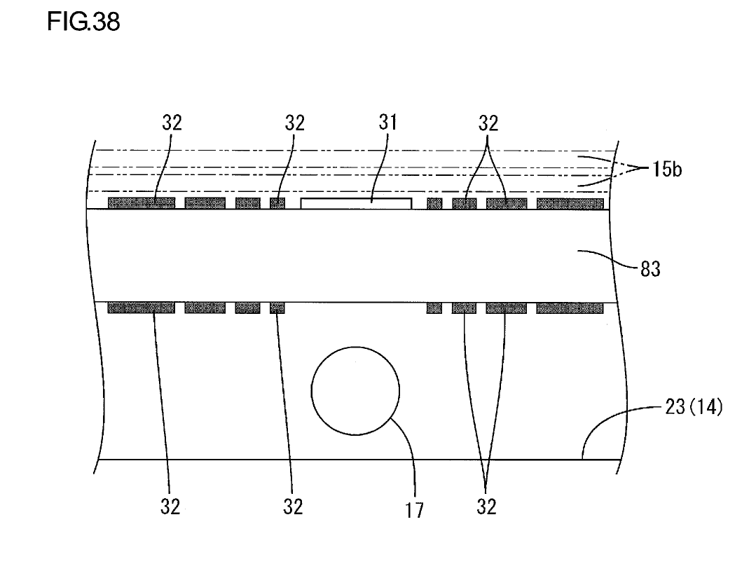

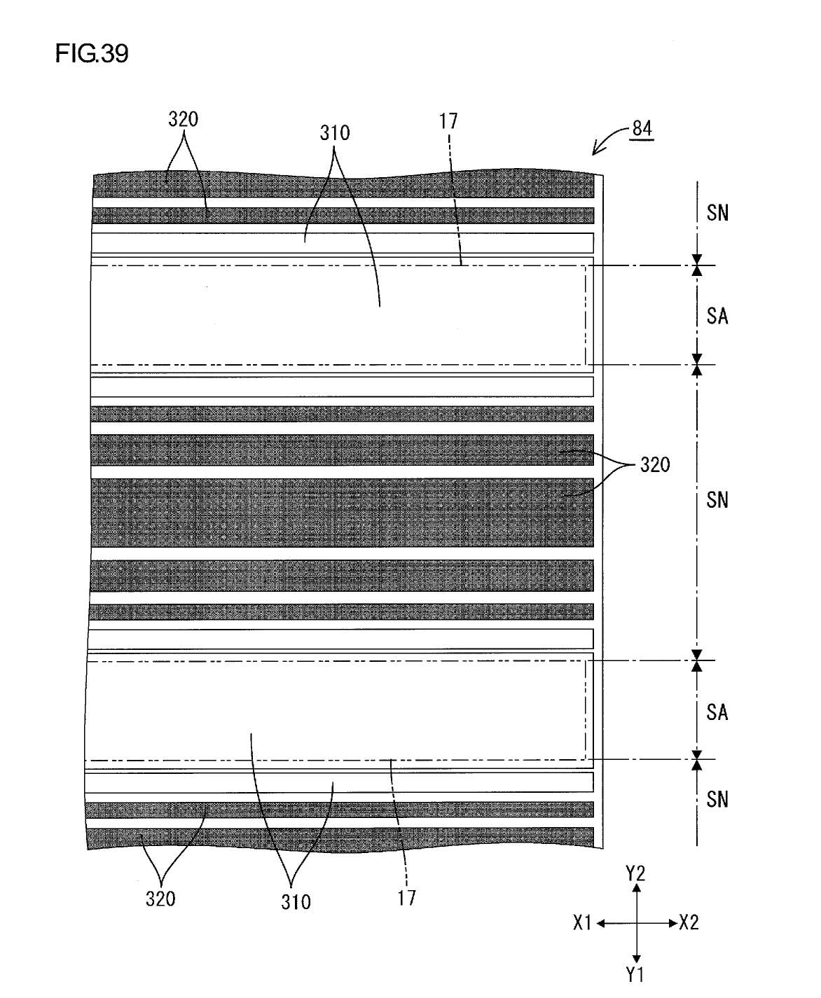

### BRIEF DESCRIPTION OF THE DRAWINGS

[FIG. 1] is an exploded perspective view illustrating a construction of a television receiver according to a first embodiment of the present invention;

[FIG. 2] is an exploded perspective view illustrating a general construction of a liquid crystal display device provided in the television receiver;

[FIG. 3] is a cross-sectional view of the liquid crystal display device along the short-side direction;

[FIG. 4] is a cross-sectional view of the liquid crystal display device along the long-side direction;

[FIG. 5] is a plan view illustrating a general construction of cold cathode tubes and a chassis provided in the liquid crystal display device;

[FIG. 6] is a plan view illustrating an enlarged general construction of a second surface of a light guide plate included in the liquid crystal display device;

[FIG. 7] is a plan view explaining light reflectance of a main portion of the second surface of the light guide plate;

[FIG. 8] is a graph illustrating a reflectivity change in the short-side direction of the light guide plate in FIG. 7;

[FIG. 9] is a typical view explaining an operation of a light reflecting portion and a light scattering portions formed on the light guide plate;

[FIG. 10] is a plan view illustrating an enlarged general construction of the second surface of the light guide plate according to a modification;

[FIG. 11] is a plan view illustrating light reflectance of a main portion of the second surface of the light guide plate in FIG. 10;

[FIG. 12] is a graph illustrating a reflectivity change in the short-side direction of the light guide plate in FIG. 10;

[FIG. 13] is a plan view illustrating an enlarged general construction of the second surface of the light guide plate according to another modification;

[FIG. 14] is a plan view illustrating light reflectance of a main portion of the second surface of the light guide plate in FIG. 13;

[FIG. 15] is a graph illustrating a reflectivity change in the short-side direction of the light guide plate in FIG. 13;

[FIG. 16] is a cross-sectional view of the liquid crystal display device along the short-side direction according to a second embodiment of the present invention;

[FIG. 17] is a plan view illustrating a general construction of cold cathode tubes and a chassis provided in the liquid crystal display device;

[FIG. 18] is a plan view illustrating an enlarged general construction of the second surface of the light guide plate included in the liquid crystal display device;

[FIG. 19] is a plan view explaining light reflectance of the second surface of the light guide plate;

[FIG. 20] is a graph illustrating a reflectivity change in the short-side direction of the light guide plate in FIG. 18;

[FIG. 21] is a plan view illustrating an enlarged general construction of the second surface of the light guide plate according to a modification;

[FIG. 22] is a plan view illustrating light reflectance of the entire second surface of the light guide plate in FIG. 21;

[FIG. 23] is a graph illustrating a reflectivity change in the short-side direction of the light guide plate in FIG. 21;

[FIG. 24] is a plan view illustrating an enlarged general construction of the second surface of the light guide plate according to another modification;

[FIG. 25] is a plan view illustrating light reflectance of the entire second surface of the light guide plate in FIG. 24;

[FIG. 26] is a graph illustrating a reflectivity change in the short-side direction of the light guide plate in FIG. 24;

[FIG. 27] is a plan view illustrating an enlarged general construction of the second surface of the light guide plate according to an additional modification;

[FIG. 28] a plan view illustrating light reflectance of the entire second surface of the light guide plate in FIG. 27;

[FIG. 29] is a graph illustrating a reflectivity change in the short-side direction of the light guide plate in FIG. 27;

[FIG. 30] is a plan view illustrating an enlarged general construction of the second surface of the light guide plate according to a further additional modification;

[FIG. 31] is a plan view illustrating a general construction of cold cathode tubes and a chassis provided in the liquid crystal display device according to a third embodiment of the present invention;

[FIG. 32] is a plan view illustrating light reflectance of the entire second surface of the light guide plate included in the liquid crystal display device;

[FIG. 33] is a graph illustrating a reflectivity change in the short-side direction of the light guide plate in FIG. 32;

[FIG. 34] is a plan view illustrating a general construction of cold cathode tubes and a chassis provided in the liquid crystal display device according to a fourth embodiment of the present invention;

[FIG. 35] a plan view illustrating light reflectance of the entire second surface of the light guide plate included in the liquid crystal display device;

[FIG. 36] is a graph illustrating a reflectivity change in the short-side direction of the light guide plate included in FIG. 35;

[FIG. 37] is a typical view illustrating a construction of the light scattering portion formed on the light guide plate according to a modification;

[FIG. 38] is a typical view illustrating a construction of the light scattering portion formed on the light guide plate according to another modification; and

[FIG. 39] is a plan view illustrating an enlarged construction of the light reflecting portion and the light scattering portion formed on the light guide plate according to an additional modification.

### BEST MODE FOR CARRYING OUT THE INVENTION

### First Embodiment

The first embodiment of the present invention will be explained with reference to FIGS. 1 to 8.

First, a construction of a television receiver TV including a liquid crystal display device 10 will be explained.

FIG. 1 is an exploded perspective view illustrating a general construction of the television receiver of this embodiment. FIG. 2 is an exploded perspective view illustrating a general construction of the liquid crystal display device included in the television receiver in FIG. 1. FIG. 3 is a cross-sectional view of the liquid crystal display device in FIG. 2 along the short-side direction. FIG. 4 is a cross-sectional view of the liquid crystal display device in FIG. 2 along the long-side direction. FIG. 5 is a plan view illustrating a general construction of cold cathode tubes and a chassis included in the liquid crystal display device in FIG. 2. In FIG. 5, the long-side direction of the chassis is referred to as an X-axis direction and the short-side direction of the chassis is referred to as a Y-axis direction.

As illustrated in FIG. 1, the television receiver TV of the present embodiment includes the liquid crystal display device 10, front and rear cabinets Ca, Cb that house the liquid crystal display device 10 therebetween, a power source P, a tuner T and a stand S. An overall shape of the liquid crystal display device (display device) 10 is a landscape rectangular. The liquid crystal display device 10 is housed in a vertical position such that a short-side direction thereof matches a vertical line. As illustrated in FIG. 2, it includes a liquid crystal panel 11 as a display panel, and a backlight device 12 (lighting device), which is an external light source. They are integrally held by a bezel 13 and the like.

Next, the liquid crystal panel 11 and the backlight device 12 included in the liquid crystal display device 10 will be explained (see FIGS. 2 to 4).

The liquid crystal panel (display panel) 11 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, color filter having color sections such as R (red), G (green) and B (blue) color sections arranged in a predetermined pattern, counter electrodes, and an alignment film are provided. Polarizing plates 11a, 11b are attached to outer surfaces of the substrates (see FIGS. 3 and 4).

As illustrated in FIG. 2, the backlight device 12 includes a chassis 14, an optical sheet set 15 (light guide plate (optical member) 15a and a plurality of optical sheets (light scattering members) 15b that are disposed between the light guide plate 15a and the liquid crystal panel 11), and frames 16. The chassis 14 has a substantially box-shape and an opening 14b on the light output side (on the liquid crystal panel 11 side). The frames 16 arranged along the long sides of the chassis 14 holds the long-side edges of the light guide plate 15a to the chassis 14. The long-side edges of the light guide plate 15a are sandwiched between the chassis 14 and the frames 16. Cold cathode tubes (light sources) 17, lamp clips 18, relay connectors 19 and lamp holders 20 are installed in the chassis 14. The lamp clips 18 are provided for mounting the cold cathode tube 17 to the chassis 14. The relay connectors 19 are connected to ends of the cold cathode tubes 17 for making electrical connection. The lamp holders 20 collectively cover ends of the cold cathode tubes 17 and the relay connectors 19. A light output side of the backlight device 12 is a side closer to the light guide plate 15a than the cold cathode tubes 17.

The chassis 14 is prepared by processing a metal plate. It is formed in a substantially shallow box shape. As illustrated in FIGS. 3 and 4, it includes a rectangular bottom plate 14a and outer rims 21, each of which extends upright from the corresponding side of the bottom plate 14a and has a substantially U shape. The outer rims 21 include short-side outer rims 21a and long-side outer rims 21b provided at the short sides and the long sides of the chassis 14, respectively. The bottom plate 14a of the chassis 14 has a plurality of mounting holes 22 along the long-side edges thereof. The relay connectors 19 are mounted in the mounting holes 22. As illustrated in FIG. 3, fixing holes 14c are provided on the upper surface of the chassis 14 along the long-side outer rims 21b to bind the bezel 13, the frames 16 and the chassis 14 together with screws and the like.

A light reflecting sheet 23 is disposed on an inner surface of the bottom plate 14a of the chassis 14 (on a side that faces the cold cathode tubes 17). The light reflecting sheet 23 is a synthetic resin sheet having a surface in white color that provides high light reflectivity. It is placed so as to cover almost entire inner surface of the bottom plate 14a of the chassis 14. As illustrated in FIG. 3, long-side edges of the light reflecting sheet 23 are lifted so as to cover the long-side outer rims 21b of the chassis 14 and sandwiched between the chassis 14 and the light guide plate 15a. With this light reflecting sheet 23, light emitted from the cold cathode tubes 17 is reflected to the light guide plate 15a.

Each cold cathode tube 17 has an elongated tubular shape. A plurality of the cold cathode tubes 17 are installed in the chassis 14 such that they are arranged parallel to each other with the long-side direction (axial direction) thereof aligned along the long-side direction of the chassis 14, as illustrated in FIG. 5. The cold cathode tubes 17 are installed over an entire area of the bottom plate 14a of the chassis 14. The cold cathode tubes 17 are held by the lamp clips 18 (not shown in FIGS. 3 and 4) so as to be supported with a small gap between the cold cathode tubes 17 and the bottom plate 14a of the chassis 14 (reflecting sheet 23) (see FIG. 4). Heat transfer members 27 are disposed in the gap so as to be in contact with a part of the cold cathode tube 17 and the bottom plate 14a (reflecting sheet 23).

Each heat transfer member 27 has a form of a rectangular plate and as illustrated in FIG. 5, each heat transfer member 27 is disposed just under each cold cathode tube 17 such that its longitudinal direction matches an axial direction of the cold cathode tubes 17. When the cold cathode tubes 17 are lit, at the portions where the heat transfer members 27 are disposed, heat can be transferred from the cold cathode tubes 17 having high temperature to the bottom plate 14a of the chassis 14 via the heat transfer members 27. Therefore, the temperature is lowered at the portions of the cold cathode tubes 17 that are in contact with the heat transfer members 27, and the coldest point is forcibly generated at the portions of the cold cathode tubes where the heat transfer members 27 are disposed.

The heat transfer members 27 are arranged in staggered layout on the bottom plate 14a of the chassis 14. That is, one heat transfer member 27 and its adjacent heat transfer members 27, 27 are offset from each other in an alignment direction (the short-side direction of the bottom plate 14a) of the cold cathode tubes 17. Namely, the one and the adjacent heat transfer members are not aligned along a line.

The holders 20 that cover the ends of the cold cathode tubes 17 and the relay connectors 19 are made of white synthetic resin. Each of them has an elongated substantially box shape that extends along the short side of the chassis 14 as illustrated in FIG. 2. As illustrated in FIG. 4, each holder 20 has steps on the front side such that the light guide plate 15a and the liquid crystal panel 11 are held at different levels. A part of the holder 20 is placed on top of a part of the corresponding short-side outer rim 21a of the chassis 14 and forms a side wall of the backlight device 12 together with the short-side outer rim 21a. An insertion pin 24 projects from a surface of the holder 20 that faces the outer rim 21a of the chassis 14. The holder 20 is mounted to the chassis 14 by inserting the insertion pin 24 into the insertion hole 25 provided in the top surface of the short-side outer rim 21a of the chassis 14.

On the outer surface of the bottom plate 14a of the chassis (on a side opposite from the cold cathode tubes 17), as illustrated in FIGS. 3 and 4, the inverter board set (light source driving board) 28 is provided so as to overlap with the ends of the cold cathode tubes 17. Accordingly, drive power is supplied from the inverter board set 28 to the cold cathode tubes 17. Each end of each cold cathode tube 17 has a terminal (not shown) for receiving drive power and electrical connection between the terminal and a harness 29a (see FIG. 4) derived from the inverter board set 28 enables supply of high-voltage drive power. Such electrical connection is established in a relay connector 19 in which the end of the cold cathode tube 17 is fitted. The holders 20 are mounted so as to cover the relay connectors 19.

On the opening 14b side of the chassis 14, the light guide plate (optical member) 15a and the optical sheet set 15 including the optical sheets (light scattering members) 15b are provided. The light guide plate 15a guides light emitted from the cold cathode tubes 17 to the optical sheet 15b. The short-side edges of the light guide plate 15a are placed on the first surface 20a of the holder 20 as described above, and does not receive a vertical force. As illustrated in FIG. 3, the long-side edges of the light guide plate 15a are sandwiched between the chassis 14 (the reflecting sheet 23) and the frame 16 and fixed. Accordingly, the light guide plate 15a covers the opening 14b of the chassis 14.

The optical sheets 15b provided on the light guide plate 15a includes two layered diffuser sheets. The optical sheets 15b convert the light that is emitted from the cold cathode tubes 17 and passes through the light guide plate 15a to planar light. The liquid crystal display panel 11 is disposed on the top surface of the top layer of the optical sheets 15b. The optical sheets 15b are held between the light guide plate 15a and the liquid crystal panel 11.

The construction of the light guide plate 15a will be explained with reference to FIGS. 6 to 8.

FIG. 6 is a plan view illustrating an enlarged general construction of a second surface of the light guide plate facing the optical sheets. FIG. 7 is a plan view explaining light reflectance of a main portion of the second surface of the light guide plate in FIG. 6. FIG. 8 is a graph illustrating a reflectivity change in the short-side direction of the light guide plate in FIG. 6. In FIGS. 6 to 8, the long-side direction of the light guide plate is referred to as an X-axis direction and the short-side direction thereof is referred to as a Y-axis direction. In FIG. 8, a horizontal axis shows the Y-axis direction (short-side direction) and the light reflectance is plotted on a graph from the point A to the point B of the Y-axis direction and from the point B to the point A′ of the Y-axis direction.

The light guide plate 15a is formed of organic high molecule preferably selected from polymethylmethacrylate, methacylate styrene and polycarbonate. The light guide plate 15a is a plate member having a substantially uniform light transmittance over an entire area (an entire area is substantially transparent). The light guide plate 15a has a surface facing the cold cathode tubes 17 (first surface 30a) and a surface facing the optical sheets 15b (second surface 30b) that is positioned opposite from the first surface 30a. As illustrated in FIG. 6, light reflecting portions 31 and light scattering portions 32 that have a dot pattern are formed on the second surface 30b of the light guide plate 15a. The dot pattern forming the light reflecting portions 31 and the light scattering portions 32 is formed by printing paste containing inorganic beads, for example, on the second surface 30b of the light guide plate 15a. Preferable printing means is serigraph, inkjet printing, screen printing and the like.

The light reflecting portion 31 has a light reflectance of 80% and the light guide plate 15a facing the cold cathode tube 17 has a light reflectance of 5%. Thus, the light reflecting portion 31 has a high light reflectance. In the present embodiment, the light reflectance of each material is represented by an average light reflectance measured with a LAV of CM-3700d (measurement area diameter of 25.4 mm) manufactured by Konica Minolta inside the measurement circle. The light reflectance of the light reflecting portion 31 is measured in the following method. The light reflecting portion 31 is formed over an entire surface of a glass substrate and the light reflectance of the surface is measured according to the above measurement means. The light reflectance of the light reflecting portion 31 is preferably 80% or more, and more preferably 90% or more. Thus, as the light reflectance of the light reflecting portion 31 is higher, the light reflection is controlled more precisely and accurately according to a pattern form of the dot pattern such as the number of dots or the area of each dot.

Each of the light reflecting portions 31 is formed by arranging a plurality of square dots in a predetermined pattern. Inorganic beads each having a diameter of approximately several hundreds μm are dispersed in each dot and each dot has a surface in white color that provides high light reflectivity. In each portion of the second surface 30b of the light guide plate 15a that overlaps the cold cathode tube 17 (light source overlapped portion SA), the light reflecting portion 31 is formed over an entire area of each portion that is overlapped with the cold cathode tube 17. Namely, the light reflecting portion 31 is formed by forming each dot all over the entire area of the light source overlapped portion SA. Further, the light reflecting portions 31 are also formed in portions of the second surface 30b that do not overlap the cold cathode tubes 17 (empty portion overlapping surface SN). The area of each dot continuously reduces in a direction away from the light source overlapped portion SA (in the Y-axis direction). In a portion of the second surface 30a furthest from the light source overlapped portion SA, that is, a portion of the second surface 30a that overlaps a center between the adjacent cold cathode tubes 17 (represented by B in FIG. 6), an area where no dot of the light reflecting portion 31 is formed is ensured. In FIG. 6, a position in the light reflecting portion 31 that overlaps a center axis of the cold cathode tube 17 is represented by A, A′.

Thus, the light reflectance of the second surface 30b of the light guide plate 15a is changed by changing the area occupied by the dots (dot pattern) of the light reflecting portions 31. The light reflectance of the light reflecting portion 31 is higher than that of the second surface 30b of the light guide plate 15a. Therefore, the light reflectance becomes relatively higher by relatively increasing the area occupied by the dots of the light reflecting portions 31, and the light reflectance becomes relatively lower by decreasing the area occupied by the dots of the light reflecting portions 31. As a method of adjusting the light reflectance, the area of each dot of the light reflecting portion 31 may be same and a distance between the adjacent dots may be changed.

In the present embodiment, the light reflectance of the second surface 30b of the light guide plate 15a changes along the short-side direction (Y-axis direction) of the light guide plate 15a as illustrated in FIGS. 7 and 8. Specifically, in the portion of the second surface 30b that overlaps the cold cathode tube 17, that is, in the light source overlapped portion SA, the light reflectance is uniform to be 80% and represents a maximum value on the light guide plate 15a. On the other hand, in the portion of the second surface 30b that does not overlap the cold cathode tube 17, that is, in the empty portion overlapping surface SN, the light reflectance decreases in a gradual manner from the portion closer to the light source overlapped portion SA toward the portion away from the light source overlapped portion SA. The light reflectance is set to a lowest value that is 5% at a middle portion (represented by B in FIG. 8) of the empty portion overlapping surface SN.

Each of the light scattering portions 32 is formed by arranging a plurality of square dots in a predetermined pattern. Inorganic beads each having a diameter of approximately from several nm to several hundreds nm are dispersed in each dot and each dot has good light scattering property and is visible as a dark point. More specifically, the area of each dot of the light scattering portions 32 decreases in a continuous manner from the middle portion of the empty portion overlapping surface SN in the short-side direction (represented by B in FIG. 6) toward the light source overlapped portions SA that are provided in adjacent to the empty portion overlapping surface SN. In other words, in the empty portion overlapping surface SN, the area of each dot of the light scattering portions 32 increases in a continuous manner from the portions closer to the light source overlapped portions SA toward the portion away from the light source overlapped portions SA.

Next, an operation of the light reflecting portions 31 and the light scattering portions 32 formed on the light guide plate 15a will be explained with reference to FIG. 9. FIG. 9 is a typical view explaining an operation of the light reflecting portion and the light scattering portions formed on the light guide plate.

As illustrated in FIG. 9, the light emitted from the cold cathode tube 17 (illustrated by a solid line in FIG. 9) passes through the light guide plate 15a from the first surface 30a to the second surface 30b. Most of the emitted light reflects off the light reflecting portion 31 formed in the light source overlapped portion SA of the second surface 30b of the light guide plate 15a to the first surface 30a, and the light that does not reflect off the light reflecting potion 31 is output to the optical sheets 15b. Among the light reflecting off the light reflecting portion 31, the light having an entry angle with respect to the first surface 30a greater than a critical angle (illustrated by a dotted line in FIG. 9) completely reflects off the first surface 30a and enters the light guide plate 15a again. On the other hand, the light having an entry angle with respect to the first surface 30a smaller than the critical angle (illustrated by a dashed line in FIG. 9) passes through the first surface 30a toward the chassis 14.

The light reflecting off the first surface 30a may reach the empty portion overlapping surface SN of the second surface 30b. On the other hand, the light passing through the light guide plate 15a to the chassis 14 reflects off the reflecting sheet 23 provided on the chassis 14 and enters the light guide plate 15a and may reach the empty portion overlapping surface SN. The light reaching the empty portion overlapping surface SN of the light guide plate 15a is scattered by the light scattering portions 32 formed on the second surface 30b corresponding to the empty portion overlapping surface SN. Accordingly, the light is output from a wide area in the empty portion overlapping surface SN of the second surface 30b.

As described above, according to the present embodiment, the light guide plate 15a formed of a member having a substantially uniform light transmittance is provided to face the cold cathode tubes 17. The light guide plate 15a has the first surface 30a facing the cold cathode tubes 17 and the second surface 30b opposite from the first surface 30a. On the second surface 30b, the light reflecting portions 31 are formed in the portions that overlap the cold cathode tubes 17 (light source overlapped portions SA), and the light scattering portions 32 are formed in the portions that do not overlap the cold cathode tubes 17 (empty portion overlapping surfaces SN). According to such a configuration, the light emitted from the cold cathode tube 17 reflects off the light reflecting portions 31 and is scattered by the light scattering portions 32, and therefore the light is effectively used and the illumination light emitted from the light guide plate 15a has uniform brightness.

The light emitted from the cold cathode tubes 17 reflects off the light reflecting portions 31 formed in the light source overlapped portions SA of the second surface 30b (does not pass through the light source overlapped portions SA), and the brightness of illumination light is suppressed with respect to the light emission amount from the cold cathode tubes 17. Further, the light emitted from the cold cathode tubes 17 reflects off the light reflecting portions 31 to be directed to the empty portion overlapping surface SN of the light guide plate 15a. The light is scattered by the light scattering portions 32 in the empty portion overlapping surface SN and output thereform. This compensates for the brightness of the portions where no cold cathode tube 17 is arranged. As a result, the illumination light output from the second surface 30b of the light guide plate 15a to the optical sheets 15b (liquid crystal panel 11) has uniform brightness.

The light guide plate 15a where the light reflecting portions 31 and the light scattering portions 32 are formed is made of a member having a substantially uniform light transmission. Therefore, the light amount passing through the light guide plate 15a is controlled only by changing the arrangement pattern of the light reflecting portions 31 and the light scattering portions 32. Accordingly, uniform light brightness can be easily obtained. The brightness of the portions where no cold cathode tube 17 is arranged can be compensated. Therefore, even if the distance between the cold cathode tubes 17 is relatively increased by reducing the number of cold cathode tubes 17 for example, uniformity of brightness can be ensured. This contributes to cost reduction and power saving.

Especially, the light guide plate 15a is arranged to face the cold cathode tubes 17 such that any other members are not arranged between the light guide plate 15a and the cold cathode tubes 17. Accordingly, it is prevented that light emitted from the cold cathode tubes 17 is refracted by other member and output without being reflected by the light reflecting portions 31. The effects of the light reflecting portions 31 can be surely obtained.

According to the present embodiment, the light reflecting portions 31 are also formed in the empty portion overlapping surface SN of the light guide plate 15a and the light reflectance of the light source overlapped portion SA is higher than that of the empty portion overlapping surface SN.

According to such a configuration, a greater amount of light passes through the empty portion overlapping surface SN than the light source overlapped portion SA. Therefore, the empty portion overlapping surface SN is not darkened and obtains a predetermined illumination brightness.

In the present embodiment, the light reflectance of the second surface 30b of the light guide plate 15a decreases in a gradual manner in a direction away from the light source overlapped portion SA.

According to such a configuration, the light reflecting off the light reflecting portion 31 of the light source overlapped portion SA relatively easily reflects off the reflecting portions 31 at the portions of the empty portion overlapping surface SN closer to the light source overlapped portion SA and thus reflecting light reaches the portions of the empty portion overlapping surface SN away from the light source overlapped portion SA. At the portions of the empty portion overlapping surface SN away from the light source overlapped portion SA, the light reflectance is relatively low, and therefore a greater amount of light passes therethrough and a predetermined brightness can be obtained. Therefore, substantially uniform illumination light can be output from the empty portion overlapping surface SN of the light guide plate 15a. Accordingly, a moderate distribution of illumination brightness can be achieved in the backlight device 12.

In the present embodiment, the light reflecting portions 31 are formed in a dot pattern having excellent light reflectivity.

In the present embodiment, the light scattering portions 32 are formed in a dot pattern having an excellent light scattering property.

Thus, since the light reflecting portions 31 and the light scattering portions 32 are formed in a dot pattern, the light reflection and the light scattering intension are controlled by a pattern form (an area of each dot in the present embodiment). Accordingly, uniform illumination brightness can be easily obtained.

In the present embodiment, the dot pattern of the light reflecting portions 31 is formed such that an area of each dot decreases in a gradual manner toward the portion of the empty portion overlapping surface SN away from the light source overlapped portion SA.

According to such a configuration, the light reflecting portion 31 has light reflectance greater than the light guide plate 15a. Therefore, the light reflectance decreases toward the portion of the empty portion overlapping surface SN away from the light source overlapped portion SA of the light guide plate 15a. A relatively greater amount of light reflects off the portions of the light guide plate 15a that light emitted from the cold cathode tubes 17 easily reaches, and a relatively smaller amount of light reflects off the portions of the light guide plate 15a that light emitted from the cold cathode tubes 17 less likely reaches. Accordingly, light passes substantially equally through the entire light guide plate 15a, and uniform illumination brightness can be obtained in the backlight device 12.

In the present embodiment, the dot pattern of the light scattering portions 32 is formed such that an area of each dot increases toward the portion of the empty portion overlapping surface SN away from the light source overlapped portion SA of the light guide plate 15a.

According to such a configuration, since the light scattering portions 32 is more excellent in the light scattering property than the light guide plate 15a, incoming light is easier to be scattered toward the portion of the empty portion overlapping surface SN away from the light source overlapped portion SA of the light guide plate 15a. Therefore, light is relatively less likely scattered at the portions of the empty portion overlapping surface SN that light emitted from the cold cathode tubes 17 easily reaches, and light is relatively easily scattered at the portions of the empty portion overlapping surface SN that light emitted from the cold cathode tubes 17 less likely reaches. Accordingly, the light is scattered in a larger area in the portions that the emission light less likely reaches. Therefore, the light passes substantially equally through the entire light guide plate 15a and uniform illumination brightness can be obtained in the backlight device 12.

In the present embodiment, the light scattering portions 32 are formed on the second surface 30b of the light guide plate 15a.

According to such a configuration, after the light enters the light guide plate 15a and reflects off the light reflecting portions 31, the light reflects off the first surface 30a again and the light is surely scattered on the second surface 30b by the light scattering portions 32 and output from the light guide plate 15a. This effectively achieves the scattering effect of the light scattering portions 32.

In the present embodiment, the optical sheets 15b that scatter the light passing through the light guide plate 15a are provided on the light output side of the light guide plate 15a.

According to such a configuration, it is suppressed that the dot pattern of the light reflecting portions 31 and the light scattering portions 32 is visible as a pattern image. This ensures uniformity of illumination light.

In the present embodiment, the heat transfer members 27 are disposed between the cold cathode tubes 17 and the bottom plate 14a of the chassis 14 for transferring heat therebetween.

According to such a configuration, heat is transferred from the cold cathode tubes 17 that are lit and have high temperature to the chassis 14 via the heat transfer members 27. Therefore, the temperature of the cold cathode tubes 17 is lowered at the portions in which the heat transfer members 27 are arranged and the coldest points are forcibly generated there. As a result, the brightness of each one of the cold cathode tubes 17 is improved and this contributes to power saving. Especially according to the configuration of the present embodiment, the cold cathode tubes 17 are arranged so as to overlap the portions of the light guide plate 15a where the light reflecting portions 31 are formed, that is, the portions having higher light reflectance. Therefore, even if the coldest points are generated in the cold cathode tubes 17, it can be designed such that the brightness nonuniformity of the cold cathode tubes 17 is less likely to be recognized.

Especially in the present embodiment, a plurality of heat transfer members 27 are arranged and one heat transfer member and its adjacent two heat transfer members are offset from each other in the alignment direction of the cold cathode tubes 17. Therefore, the heat transfer members 27 are not arranged on the straight line and the nonuniformity brightness is less likely to be recognized.

The present invention is not limited to the first embodiment, and may include following modifications for example. In the following modifications, the same parts as the above embodiment are indicated by the same symbols and will not be illustrated and explained.

### First Modification of First Embodiment

One modification of a configuration of the light reflecting portions on the second surface 30b of the light guide plate 15a is illustrated in FIGS. 10 to 12. FIG. 10 is a plan view illustrating an enlarged general construction of the second surface of the light guide plate facing the optical sheets according to this modification. FIG. 11 is a plan view illustrating light reflectance of a main portion of the second surface of the light guide plate in FIG. 10. FIG. 12 is a graph illustrating a reflectivity change in the short-side direction of the light guide plate in FIG. 10. In FIGS. 10 to 12, the long-side direction of the light guide plate is referred to as an X-axis direction and the short-side direction thereof is referred to as a Y-axis direction. In FIG. 12, a horizontal axis shows the Y-axis direction (short-side direction) and the light reflectance is plotted on a graph from the point A to the point B of the Y-axis direction and from the point B to the point A′ of the Y-axis direction.

As illustrated in FIG. 10, a light guide plate 150 has light reflecting portions 31-A and light scattering portions 32 formed in a dot pattern on a surface facing the optical sheets 15b (second surface 150b). An area of each dot of the light reflecting portions 31-A is greatest in portions that are overlapped with the cold cathode tubes 17 (light source overlapped portions SA) and an area of each dot of the light reflecting portions 31-A decreases in a stepwise manner in a direction away from the light source overlapped portions SA.

Since the light reflecting portions 31-A are thus formed, the light source overlapped portion SA has the highest light reflectance in the second surface 150b of the light guide plate 150, as illustrated in FIGS. 11 and 12. On the other hand, in the portions that do not overlap the cold cathode tubes 17 (empty portion overlapping surface SN), the light reflectance decreases in a stepwise manner from the portion closer to the light source overlapped portion SA toward the portion farther therefrom. Namely, in the empty portion overlapping surface SN of the second surface 150b of the light guide plate 150, the light reflectance changes step by step along the short-side direction (Y-axis direction) of the light guide plate 150.

More specifically, as illustrated in FIG. 11, a first area 41 having relatively high light reflectance is provided in the light source overlapped portion SA on the second surface 150b of the light guide plate 150, and second areas 42, 42 having light reflectance relatively lower than the first area 41 are provided next to the first area 41 in the empty portion overlapping surface SN located at the sides of the first area 41. Further, in the empty portion overlapping surface SN, third areas 43, 43 having light reflectance relatively lower than the second areas 42 are provided at the sides of the second areas 42, fourth areas 44, 44 having light reflectance lower than the third areas 43 are provided at the sides of the third areas 43, and fifth areas 45, 45 having light reflectance lower than the fourth areas 44 are provided at the sides of the fourth areas 44.

In this modification, as illustrated in FIG. 10, the light reflectance of the second surface 150b of the light guide plate 150 is 80% in the first area 41, 50% in the second area 42, 40% in the third area 43, 30% in the fourth area 44, and 5% in the fifth area 45. In the first area 41 to the fourth area 44, the area of each dot of the light reflecting portions 31 is changed to determine the above light reflectance, and the light reflectance in the fifth area 45 in which no light reflecting portion 31 is provided is represented by the light reflectance of the light guide plate 150.

A plurality of areas 42, 43, 44, 45 having different light reflectance are defined in the empty portion overlapping surface SN of the second surface 150b of the light guide plate 150. The light reflectance is reduced from the second area 42 to the fifth area 45 sequentially in this order such that the light reflectance decreases in a stepwise manner from the portion closer to the light source overlapped portion SA toward the portion farther therefrom.

According to such a configuration, the brightness distribution of illumination light in the empty portion overlapping surface SN is made moderate. With the above means for forming a plurality of areas 42, 43, 44, 45 having different light reflectance, a manufacturing method of the light guide plate 150 becomes simple and this contributes to a cost reduction.

### Second Modification of First Embodiment

Another modification of the configuration of the light reflecting portions on the second surface 30b of the light guide plate 15a will be explained with reference to FIGS. 13 to 15. FIG. 13 is a plan view illustrating an enlarged general construction of the second surface of the light guide plate facing the optical sheets according to another modification. FIG. 14 is a plan view illustrating light reflectance of a main portion of the second surface of the light guide plate in FIG. 13. FIG. 15 is a graph illustrating a reflectivity change in the short-side direction of the light guide plate in FIG. 13. In FIGS. 13 to 15, the long-side direction of the light guide plate is referred to as an X-axis direction and the short-side direction thereof is referred to as a Y-axis direction. In FIG. 15, a horizontal axis shows the Y-axis direction (short-side direction) and the light reflectance is plotted on a graph from the point A to the point B of the Y-axis direction and from the point B to the point A′ of the Y-axis direction.

As illustrated in FIG. 13, a light guide plate 250 has light reflecting portions 31-B and light scattering portions 32 formed in a dot pattern on a surface facing the optical sheets 15b (second surface 250b). An area of each dot of the light reflecting portions 31-B is greatest in the light source overlapped portions SA of the second surface 250b of the light guide plate 250 and an area of each dot of the light reflecting portions 31-B decreases in a continuous manner in a direction away from the light source overlapped portions SA (in the Y-axis direction). Especially in this modification, a side length of a dot formed in the light source overlapped portion SA is smaller than a width of the cold cathode tube 17 and a space is formed between the adjacent dots in the light source overlapped portion SA.

Since the light reflecting portions 31-B are thus formed, the portion of the second surface 250b of the light guide plate 250 that overlaps a center axis of the cold cathode tube 17 in the short-side direction (Y-axis direction) (represented by A and A′ in FIGS. 14 and 15) has the highest light reflectance, as illustrated in FIGS. 14 and 15. The light reflectance decreases in a continuous and gradual manner in a direction away from the center axis. Namely, also in the light source overlapped portion SA of the light guide plate 250, the light reflectance decreases from the middle portion to the ends along the Y-axis direction.

In this modification, the light reflectance of the second surface 250b of the light guide plate 250 is 70% in the portion that overlaps the center axis of the cold cathode tube 17 and decreases in a continuous manner toward the ends of the empty portion overlapping surface SN, as illustrated in FIG. 15. Also in the empty portion overlapping surface SN, the light reflectance decreases in a continuous manner toward the center of the empty portion overlapping surface SN (represented by B in FIGS. 14 and 15) and is 5% at the center of the empty portion overlapping surface SN.

According to such a configuration, the brightness distribution of illumination light is made moderate in the light guide plate 250 and the backlight device 12 can obtain a moderate illumination brightness distribution.

### Second Embodiment

A second embodiment of the present invention will be explained with reference to FIGS. 16 to 20. The second embodiment differs from the first embodiment in that an arrangement configuration of the cold cathode tubes is changed, and other components and configurations are same as the above embodiment. The same parts as the above embodiment are indicated by the same symbols and will not be explained. FIG. 16 is a cross-sectional view of the liquid crystal display device along the short-side direction according to the second embodiment. FIG. 17 is a plan view illustrating a general construction of cold cathode tubes and a chassis provided in the liquid crystal display device.

A plurality of cold cathode tubes 17 are arranged in a portion of the chassis 14 such that they are arranged parallel to each other with having a relatively small distance therebetween. More specifically, as illustrated in FIGS. 16 and 17, a bottom plate 50 of the chassis 14 (a portion facing a light guide plate 60) is defined in the short-side direction equally in a first end portion 50A, a second end portion 50B that is located at an end opposite from the first end portion 50A and a middle portion 50C that is sandwiched between the first end portion 50A and the second end portion 50B. The cold cathode tubes 17 are arranged in the middle portion 50C of the bottom plate 50 and a light source installation area LA is formed in the middle portion 50C. On the other hand, no cold cathode tube 17 is arranged in the first end portion 50A and the second end portion 50B of the bottom plate 50 and an empty area LN is formed in the first end portion 50A and the second end portion 50B. Namely, the cold cathode tubes 17 are arranged in the middle portion of the bottom plate 50 of the chassis 14 in the short-side direction to form the light source installation area LA. The light source installation area LA is smaller than (a half of) the total area of the empty areas LN. In the present embodiment, each of the first end portion 50A, the second end portion 50B and the middle portion 50C has an equal area (is equally defined). However, a ratio between the portions can be changed and accordingly, the area of the light source installation area LA and the area of the empty areas LN (an area ratio between the areas LA and LN) also can be changed.

In the light source installation area LA of the bottom plate 50 of the chassis 14, the cold cathode tubes 17 are held to be supported with a small gap between the cold cathode tubes 17 and the bottom plate 50 of the chassis 14 (reflecting sheet 23) (see FIG. 16). Heat transfer members 27 are disposed in the gap so as to be in contact with a part of the cold cathode tube 17 and the bottom plate 50 (reflecting sheet 23) (see FIG. 17).

In each of the empty areas LN of the bottom plate 50 of the chassis 14, that is, in each of the first end portion 50A and the second end portion 50B of the bottom plate 50, a convex reflecting portion (reflecting portion) 51 extends along the long-side direction of the bottom plate 50. The convex reflecting portion 51 is made of a synthetic resin and has a surface in white color that provides high light reflectivity. Each convex reflecting portion 51 has two sloped surfaces (directing surfaces) 51a, 51a that face the cold cathode tubes 17 and are sloped toward the bottom plate 50. The convex reflecting portion 51 is provided such that its longitudinal direction matches an axial direction of the cold cathode tubes 17 arranged in the light source installation area LA. One sloped surface 51a directs light emitted from the cold cathode tubes 17 to the light guide plate 60.

An inverter board set 52 is arranged on an outer side of the bottom plate 50 of the chassis 14 (on an opposite side from the side where the cold cathode tubes 17 are arranged), as illustrated in FIG. 16. The inverter board set 52 supplies drive power to the cold cathode tubes 17. The inverter board set 52 is not formed over the entire length of the short-side direction of the bottom plate 50, and is arranged in the portion of the bottom plate 50 that overlaps the light source installation area LA, that is, the middle portion 50C of the bottom plate 50.

A configuration of the light guide plate 60 provided on the opening 14b side of the chassis 14 will be explained in details with reference to FIGS. 18 to 20. FIG. 18 is a plan view illustrating an enlarged general construction of the second surface of the light guide plate facing the optical sheets. FIG. 19 is a plan view explaining light reflectance of the entire second surface of the light guide plate in FIG. 18. FIG. 20 is a graph illustrating a reflectivity change in the short-side direction of second surface of the light guide plate in FIG. 18. In FIGS. 18 to 20, the long-side direction of the diffuser plate is referred to as an X-axis direction and the short-side direction thereof is referred to as a Y-axis direction. In FIG. 20, a horizontal axis shows the Y-axis direction (short-side direction) and the light reflectance is plotted on a graph from the end closer to Y1 (Y1 end) to the middle portion and from the middle portion to the end closer to Y2 (Y2 end) in the Y-axis direction.

The light guide plate 60 is arranged to face the cold cathode tubes 17 and the bottom plate 50 of the chassis 14. As illustrated in FIG. 19, the middle portion of the light guide plate 60 in the short-side direction corresponds to the portion that overlaps a light source installation area LA of the bottom plate 50 (referred to as a light source installation area overlapped portion DA). Each of the two end portions of the light guide plate 60 in the short-side direction corresponds to the portion that overlaps an empty area LN of the bottom plate 50 (referred to as an empty area overlapping surface DN). In this embodiment, on the light guide plate 60, the portions that do not overlap the cold cathode tubes 17 (empty portion overlapping surfaces SN) include the empty area overlapping surfaces DN and the portions in the light source installation area overlapped portion DA except for the portions that overlap the cold cathode tubes 17 (light source overlapped portions SA).

The light reflecting portions 31 and the light scattering portions 32 having a dot pattern are formed on a second surface 60b of the light guide plate 60 facing the optical sheets 15b (a surface opposite from the one facing the cold cathode tubes 17) as illustrated in FIG. 18. More specifically, in the light source installation area overlapped portion DA of the second surface 60b of the light guide plate 60, the light reflecting portion 31 is formed by forming the dot over the entire portion that overlaps the cold cathode tube 17. Square dots of the light scattering portions 32 are formed in the portion of the light guide plate 60 that overlaps an elongated area between the adjacent cold cathode tubes 17, 17, that is the portion of the light guide plate 60 that does not overlap the cold cathode tube 17.

On the empty area overlapping surface DN of the second surface 60b of the light guide plate 60, an area of each dot of the light reflecting portions 31 decreases in a continuous manner in a direction away from the light source installation area overlapped portion DA (in the Y-axis direction). An area where no dot of the light reflecting portions 31 is formed is ensured in the portions farthest away from the light source installation area overlapped portion DA, that is, at the two end portions of the light guide plate 60 in the short-side direction. On the empty area overlapping surface DN of the second surface 60b of the light guide plate 60, an area of each dot of the light scattering portions 32 increases in a continuous manner in a direction away from the light source installation area overlapped portion DA (in the Y-axis direction). Namely, the light guide plate 60 is configured such that light is easily scattered at the two end portions of the light guide plate 60 in the short-side direction compared to the middle portion.

The light reflectance of the second surface 60b of the light guide plate 60 changes by the portions of the light guide plate 60 by changing an area of each dot (dot pattern) of the light reflecting portions 31. In this embodiment, the light reflectance of the second surface 60b of the light guide plate 60 changes along the short-side direction (Y-axis direction) over the entire area of the light guide plate 60. The middle portion (middle portion of the Y-axis in FIG. 20) of the second surface 60b of the light guide plate 60 in the short-side direction (Y-axis) has the highest light reflectance of 70%. The light reflectance of the second surface 60b decreases toward the two end portions in the Y-axis direction. Each of the end portions (Y1 end and Y2 end of the Y-axis in FIG. 20) has the light reflectance of the light guide plate 15a itself that is 5%. Namely, on the second surface 60b of the light guide plate 60, the light source installation area overlapped portion DA has the highest light reflectance, and the light reflectance of the empty area overlapping surface DN is higher at the portion closer to the light source installation area overlapped portion DA and decreases in a continuous and gradual manner toward the portion farther therefrom.

As is explained above, according to the present embodiment, the chassis 14 included in the backlight device 12 is configured such that the bottom plate 50 facing the light guide plate 60 is defined in the first end portion 50A, the second end portion 50B and the middle portion 50C sandwiched between the first and second end portions 50A and 50B. The middle portion 50C corresponds to the light source installation area LA where the cold cathode tubes 17 are arranged and the first end portion 50A and the second end portion 50B correspond to the empty areas LN where no cold cathode tube 17 is arranged. Thus, compared to a case in which the cold cathode tubes are installed evenly in the entire chassis, the number of cold cathode tubes 17 is reduced and a cost reduction and power saving of the backlight device 12 are achieved.

In the portion of the second surface 60b of the light guide plate 60 facing the cold cathode tubes 17 that overlaps the light source installation area LA (light source installation area overlapped portion DA), the light reflecting portions 31 are formed in the portions that overlap the cold cathode tubes 17. Further, in the portions of the second surface 60b that overlap the empty areas LN (empty area overlapping surface DN), an area of each dot of the light reflecting portions 31 decreases in a continuous manner from the portion closer to the light source installation area overlapped portion DA toward the portion away therefrom. As a result, on the second surface 60b of the light guide plate 60, the light source installation area overlapped portion DA has a light reflectance higher than the empty area overlapping surface DN. This suppresses brightness nonuniformity of illumination light from the backlight device 12.

As described above, if the empty area LN where no cold cathode tube 17 is arranged is provided, light is not output from the empty area LN. Therefore, the illumination light output from the backlight device 12 is dark at the portion corresponding to the empty area LN and this may cause uneven light distribution. However, according to the configuration of the present invention, light output from the light source installation area LA first reaches the light source installation area overlapped portion DA of the light guide plate 60 that is the portion having the relatively high light reflectance. Therefore, most of the light reflects off the light source installation area overlapped portion DA (does not pass through the light source installation area overlapped portion DA), and the brightness of illumination light is suppressed with respect to the light emission amount from the cold cathode tubes 17. On the other hand, the light that reflects off the light source installation area overlapped portion DA further reflects off the first surface 60a of the light guide plate 60 and the reflecting sheet 23 and the like in the chassis 14 and the light reaches the empty area overlapping surface DN of the light guide plate 60. The light reflectance of the empty area overlapping surface DN is relatively low and a larger amount of light passes through the empty area overlapping surface DN and thus predetermined brightness of illumination light is achieved.

The light scattering portions 32 are formed on the empty area overlapping surface DN of the light guide plate 60. An area of each dot of the light scattering portions 32 increases in a continuous manner toward the portion away from the light source installation area overlapped portion DA. Accordingly, in the empty area overlapping surface DN, the light is easier to be scattered in the portion away from the light source installation area overlapped portion DA, that is the portion that the light less likely reaches. Therefore, the light entering the portion can be output from a wide area of the second surface 60b. As a result, the cold cathode tubes 17 are not necessary to be installed in the entire chassis 14 to maintain the illumination light uniformity of the backlight device 12, and a cost reduction and power saving are achieved.

In the present embodiment, on the bottom plate 50 of the chassis 14, the light source installation area LA is smaller than the total area of the empty areas LN.

Even if the light source installation area LA is relatively small, the light reflecting portions 31 and the light scattering portions 32 are provided on the light guide plate 60 like the configuration of the present embodiment to execute the reflecting function and the scattering function in the light guide plate 60. Thereby, the light emitted from the cold cathode tubes 17 can be directed toward the empty area overlapping surface DN that overlaps the empty area LN. This maintains uniformity of illumination brightness and greater effects can be expected in lowering a cost and saving power.

In the present embodiment, the light source installation area LA is provided in the middle portion 30C of the bottom plate 50 of the chassis 14.

According to such a configuration, sufficient brightness is ensured in the middle portion of the backlight device 12 and the brightness at the middle portion of a display is ensured in the television receiver TV including the backlight device 12, and therefore good visibility can be obtained.

In the present embodiment, in the portion of the light guide plate 60 that overlaps the empty area LN (empty area overlapping surface DN), the light reflectance of the second surface 60b is higher in a portion closer to the portion of the light guide plate 60 that overlaps the light source installation area LA (light source installation area overlapped portion DA) than a portion farther from the light source installation area overlapped portion DA.

According to such a configuration, the light that reaches the empty area overlapping surface DN of the light guide plate 60 is relatively easily reflected in the portion closer to the light source installation area overlapped portion DA and the reflected light reaches the portion farther from the light source installation area overlapped portion DA. In the portion away from the light source installation area overlapped portion DA, the light reflectance is relatively low. Therefore, a larger amount of light passes therethrough and predetermined brightness of illumination light can be obtained. Therefore, the brightness of illumination light is set to substantially uniform in the empty area overlapping surface DN (empty area LN) and a moderate distribution of illumination brightness can be achieved in the backlight device 12.

Especially in the present embodiment, on the second surface 60b of the light guide plate 60, the light reflectance in the empty area installation area overlapping surface DN decreases in a gradual manner from the portion closer to the light source installation area overlapped portion DA to the portion away from the light source installation area overlapped portion DA.

The light reflectance in the empty area overlapping surface DN decreases in a continuous and gradual manner from the portion closer to the light source installation area overlapped portion DA to the portion away therefrom so as to have a gradation. This makes the distribution of illumination light brightness in the empty area overlapping surface DN (empty area LN) to be further moderate and the backlight device 12 can achieve a further moderate distribution of illumination light brightness.

In the present embodiment, the convex reflecting portions 51 having the sloped surfaces 51a that reflect (direct) the light emitted from the cold cathode tubes 17 to the light guide plate 60 are provided in the empty areas LN of the bottom plate 50 of the chassis 14.

According to such a configuration, the light emitted from the cold cathode tubes 17 that are arranged in the light source installation area LA can be reflected to the light guide plate 60 by the sloped surfaces 51a of the convex reflecting portions 51. Therefore, the emitted light is effectively used and it is further reliably suppressed that the empty areas LN are darkened.

In the present embodiment, the inverter board set 52 that supplies drive power to the cold cathode tubes 17 is arranged in the portion of the chassis 14 that overlaps the light source installation area LA.

This reduces a distance between the cold cathode tubes 17 and the inverter board set 29 to the smallest possible distance. This shortens the length of the harness for supplying drive power of high voltage from the inverter board set 52 and this ensures reliable safety. Especially, when the cold cathode tubes 17 are arranged in a portion of the bottom plate 50 like the present embodiment, the size of the inverter board set 52 is enabled to be minimum. This lowers a cost compared to the case in that the inverter board set is formed over the entire chassis 14. Also, surrounding components can be arranged in a space generated due to size reduction of the inverter board set 52 and this makes the backlight device 12 thinner.

In the present embodiment, the heat transfer members 27 are disposed between the cold cathode tubes 17 and the bottom plate 50 of the chassis 14 for transferring heat therebetween.

According to such a configuration, heat is transferred from the cold cathode tubes 17 that are lit and have high temperature to the chassis 14 via the heat transfer members 27. Therefore, the temperature of the cold cathode tubes 17 is lowered at the portions in which the heat transfer members 27 are arranged and the coldest points are forcibly generated there. As a result, the brightness of each one of the cold cathode tubes 17 is improved and this contributes to power saving. Especially according to the configuration of the present invention, the cold cathode tubes 17 are arranged only in the light source installation area LA. Therefore, compared to the case in that the cold cathode tubes 17 are installed evenly in the entire chassis 14, the distance between the cold cathode tubes 17 can be reduced and the cold cathode tubes 17 are installed to overlap with the portions of the light guide plate 60 having high light reflectance. Therefore, even if the coldest points are generated in the cold cathode tubes 17, it can be designed such that the brightness nonuniformity of the cold cathode tubes 17 is less likely to be recognized.

The second embodiment of the present invention is described, however, the present invention is not limited to the above embodiment, and may include following modifications for example. In the following modifications, the same parts as the above embodiment are indicated by the same symbols and will not be illustrated and explained.

### First Modification of Second Embodiment

One modification of the configuration of the light reflecting portions on the second surface 60b of the light guide plate 60 will be explained with reference to FIGS. 21 to 23. FIG. 21 is a plan view illustrating an enlarged general construction of the second surface of the light guide plate facing the optical sheets according to another modification. FIG. 22 is a plan view illustrating light reflectance of the entire second surface of the light guide plate in FIG. 21. FIG. 23 is a graph illustrating a reflectivity change in the short-side direction of the light guide plate in FIG. 21. In FIG. 23, a horizontal axis shows the Y-axis direction (short-side direction) and the light reflectance is plotted on a graph from the end closer to the Y1 (Y1 end) to the middle portion in the Y-axis direction and from the middle portion to the end closer to the Y2 (Y2 end).

The light reflecting portions 31-C and the light scattering portions 32 having a dot pattern are formed on a surface of a light guide plate 160 facing the optical sheets 15b (a second surface 160b) as illustrated in FIG. 21. An area of each dot of the light reflecting portions 31-C is largest at a position in the light source installation area overlapped portion DA (in the portion that overlaps the light source installation area LA) that overlaps the cold cathode tube 17, and an area of each dot of the light reflecting portions 31-C decreases in a stepwise manner in a direction away from the light source installation area overlapped portion DA.

Since the light reflecting portions 31-C thus formed, the light source installation area overlapped portion DA has the highest light reflectance in the entire second surface 160b of the light guide plate 160, as illustrated in FIGS. 22 and 23. In the portion of the light guide plate 160 that overlaps the empty area LN (empty area overlapping surface DN), the light reflectance decreases in a stepwise manner from the portion closer to the light source installation area overlapped portion DA toward the portion farther therefrom. In the light source installation area overlapped portion DN of the second surface 160b of the light guide plate 160, the light reflectance changes in a stripe pattern along the short-side direction (Y-axis direction) of the light guide plate 160.

More specifically, as illustrated in FIG. 22, a first area 61 having relatively high light reflectance is provided in the light source installation area overlapped portion DA that is located in the middle portion of the light guide plate 160, and second areas 62, 62 having light reflectance relatively lower than the first area 61 are provided next to the first area 61 in the empty area overlapping surface DN located at the sides of the first area 61. Further, in the empty area overlapping surface DN, third areas 63, 63 having light reflectance relatively lower than the second areas 62 are provided at the sides of the second areas 62, fourth areas 64, 64 having light reflectance lower than the third areas 63 are provided at the sides of the third areas 63, and fifth areas 65, 65 having light reflectance lower than the fourth areas 64 are provided at the sides of the fourth areas 64.

In this modification, as illustrated in FIG. 23, the light reflectance of the second surface 160b of the light guide plate 160 is 70% in the first area 61, 55% in the second area 62, 30% in the third area 63, 15% in the fourth area 63, and 5% in the fifth area 65. In the first area 61 to the fourth area 64, the area of each dot of the light reflecting portions 31-C is changed to determine the above light reflectance, and the light reflectance in the fifth area 65 in which no light reflecting portion 31-C is provided is represented by the light reflectance of the light guide plate 160.

A plurality of areas 62, 63, 64, 65 having different light reflectance are defined in the empty area overlapping surface DN of the second surface 160b of the light guide plate 160. The light reflectance is reduced from the second area 62 to the fifth area 65 sequentially in this order such that the light reflectance decreases in a stepwise manner from the portion closer to the light source installation area overlapped portion DA toward the portion farther therefrom.

According to such a configuration, the brightness distribution of illumination light in the empty area overlapping surface DN is made moderate. With the means for forming a plurality of areas 62, 63, 64, 65 having different light reflectance, a manufacturing method of the light guide plate 160 becomes simple and this contributes to a cost reduction.

### Second Modification of Second Embodiment

Another modification of the configuration of the light reflecting portions on the second surface 60b of the light guide plate 60 is illustrated in FIGS. 24 to 26. FIG. 24 is a plan view illustrating an enlarged general construction of the second surface of the light guide plate facing the optical sheets. FIG. 25 is a plan view illustrating light reflectance of the entire second surface of the light guide plate in FIG. 24. FIG. 26 is a graph illustrating a reflectivity change in the short-side direction of the light guide plate in FIG. 24.

In FIGS. 24 to 26, the long-side direction of the light guide plate is referred to as an X-axis direction and the short-side direction thereof is referred to as a Y-axis direction. In FIG. 26, a horizontal axis shows the Y-axis direction (short-side direction) and the light reflectance is plotted on a graph from the end closer to Y1 (Y1 end) to the middle portion in the Y-axis direction and from the middle portion to the end closer to Y2 (Y2 end).

Light reflecting portions 31-D and the light scattering portions 32 having a dot pattern are formed on a surface of a light guide plate 260 facing the optical sheets 15b (a second surface 260b) as illustrated in FIG. 24. An area of each dot of the light reflecting portions 31-D is largest at a position in the light source installation area overlapped portion DA of the second surface 260b of the light guide plate 260. An area of each dot of the light reflecting portions 31-D decreases in a continuous manner in a direction away from the light source installation area overlapped portion DA (in the Y-axis direction). Especially in this modification, also in the light source installation area overlapped portion DA, an area of each dot is largest at a middle portion in the short-side direction (Y-axis direction) and decreases in a continuous manner toward the ends (borders between the light source installation area overlapped portion DA and the empty area overlapping surface DN).

Since the light reflecting portions 31-D are thus formed, the second surface 260b of the light guide plate 260 has the highest light reflectance at a middle portion (illustrated by middle in FIG. 26) in the short-side direction (Y-axis direction), as illustrated in FIGS. 25 and 26. The light reflectance decreases in a continuous and gradual manner toward the portion away from the middle portion. Namely, also in the light source installation area overlapped portion DA of the light guide plate 260, the light reflectance decreases from the middle portion to the ends along the Y-axis direction.

In this modification, the light reflectance of the light guide plate 260 is 70% in the middle portion in the short-side direction and is 5% at the ends Y1 and Y2. The light reflectance of the light guide plate 260 changes in a continuous manner between 70% and 5% from the middle portion to the two ends, as illustrated in FIG. 26.

According to such a configuration, the brightness distribution of illumination light is made moderate in the light guide plate 260 and the backlight device 12 can obtain a moderate illumination brightness distribution. Such a configuration is especially preferable for the television receiver TV including the backlight device 12 that has high brightness in the vicinity of the middle portion of the display.

### Third Modification of Second Embodiment

Additional modification of the configuration of the light reflecting portions on the second surface 30b of the light guide plate 15a will be explained with reference to FIGS. 27 to 29. FIG. 27 is a plan view illustrating an enlarged general construction of the second surface of the light guide plate facing the optical sheets. FIG. 28 is a plan view illustrating light reflectance of the entire second surface of the light guide plate in FIG. 27. FIG. 29 is a graph illustrating a reflectivity change in the short-side direction of the light guide plate in FIG. 27. In FIGS. 27 to 29, the long-side direction of the light guide plate is referred to as an X-axis direction and the short-side direction thereof is referred to as a Y-axis direction. In FIG. 29, a horizontal axis shows the Y-axis direction (short-side direction) and the light reflectance is plotted on a graph from the end closer to Y1 (Y1 end) to the middle portion in the Y-axis direction and from the middle portion to the end closer to Y2 (Y2 end).

As illustrated in FIG. 27, a light guide plate 360 has light reflecting portions 31-E and light scattering portions 32 formed in a dot pattern on a surface facing the optical sheets 15b (second surface 360b). The light reflecting portions 31-E are formed only on the portions of the light source installation area overlapped portion DA that overlap the cold cathode tubes 17. On the other hand, the light scattering portions 32 are formed on the portions of the second surface 260b of the light guide plate 360 that do not overlap the cold cathode tubes 17. Especially on the empty area overlapping surface DN, an area of each dot increases in a continuous manner from the portion closer to the light source installation area overlapped portion DA toward the portion farther therefrom.

Since the light reflecting portions 31-D are thus formed, the light reflectance of the second surface 360b of the light guide plate 360 is relatively high in the light source installation area overlapped portion DA and relatively low in the empty area overlapping surface DN, as illustrated in FIGS. 28 and 29. The light reflectance is uniform in the light source installation area overlapped portion DA and in the empty area overlapping surface DN. In this modification, as illustrated in FIG. 29, the light reflectance of the second surface 360b of the light guide plate 360 is 70% in the light source installation area overlapped portion DA that is located in the middle portion and the light reflectance is 5% in the empty area overlapping surfaces DN that are located at the two ends.

According to such a configuration, the light reflecting portions 31-D are formed only in the middle portion of the second surface 360b of the light guide plate 360. This simplifies a manufacturing method of the light guide plate 360 and this contributes to cost reduction.

### Fourth Modification of Second Embodiment

Additional modification of the configuration of the light reflecting portions on the second surface 60b of the light guide plate 60 will be explained with reference to FIG. 30. FIG. 30 is a plan view illustrating an enlarged general construction of the second surface of the light guide plate facing the optical sheets.

The light reflecting portions 31-F and the light scattering portions 32 having a dot pattern are formed on a surface of a light guide plate 460 facing the optical sheets 15b (a second surface 460b) as illustrated in FIG. 30. An area of each dot of the light reflecting portions 31-F is largest at a position in the light source installation area overlapped portion DA (in the portion that overlaps the light source installation area LA) that overlaps the cold cathode tube 17, and an area of each dot of the light reflecting portions 31-F decreases in a stepwise manner in a direction away from the light source installation area overlapped portion DA.

On the other hand, the light scattering portions 32 are not formed in the light source installation area overlapped portion DA and formed only in the empty area overlapping surfaces DN. In the empty area overlapping surfaces DN, an area of each dot of the light scattering portions 32 decreases in a continuous manner from the portion closer to the light source installation area overlapped portion DA toward the portion farther therefrom. Accordingly, even in the empty areas LN where no cold cathode 17 is arranged, light is output from a wide area of the empty area overlapping surface DN of the second surface 460b that overlaps the empty areas LN.

### Third Embodiment

Next, a third embodiment of the present invention will be explained with reference to FIGS. 31 to 33. In the third embodiment, the arrangement of the cold cathode tubes and the configuration of the light guide plate are modified, and other configurations are same as the above embodiments. The same parts as the above embodiments are indicated by the same symbols and will not be explained. FIG. 31 is a plan view illustrating a general construction of cold cathode tubes and a chassis provided in the liquid crystal display device according to the third embodiment. FIG. 32 is a plan view illustrating light reflectance of the entire second surface of the light guide plate included in the liquid crystal display device. FIG. 33 is a graph illustrating a reflectivity change in the short-side direction of the light guide plate in FIG. 32. In FIGS. 31 to 33, the long-side direction of the chassis and the light guide plate is referred to as X-axis direction and the short-side direction thereof is referred to as Y-axis direction. In FIG. 33, a horizontal axis represents the Y-axis direction (short-side direction) and the light reflectance is plotted on a graph from the end closer to the Y1 (Y1 end) to the middle portion and from the middle portion to the end closer to the Y2 (Y2 end) in the Y-axis direction.

A plurality of cold cathode tubes 17 are arranged in portions of the chassis 14 such that they are arranged parallel to each other with having a small distance therebetween. More specifically, as illustrated in FIG. 31, a bottom plate 70 of the chassis 14 (a portion facing a light guide plate 80) is defined in the short-side direction equally in a first end portion 70A, a second end portion 70B that is located at an end opposite from the first end portion 70A and a middle portion 70C that is sandwiched between the first end portion 70A and the second end portion 70B. The same number of cold cathode tubes 17 are arranged in the first end portion 70A and the second end portion 70B of the bottom plate 70 respectively and a light source installation area LA-1 is formed in the first end portion 70A and the second end portion 70B. On the other hand, no cold cathode tube 17 is arranged in the middle portion 70C of the bottom plate 70 and an empty area LN-1 is formed in the middle portion 70C. Namely, the cold cathode tubes 17 are arranged in the two end portions of the bottom plate 70 of the chassis 14 in the short-side direction to form the light source installation areas LA-1.

On the other hand, a light guide plate 80 is provided to face the bottom plate 70 of the chassis 14 and has portions that overlap the light source installation areas LA-1 (referred to as light source installation area overlapped portions DA-1) and a portion that overlaps the empty area LN-1 (referred to as a empty area overlapping surface DN-1). The light guide plate has a first surface 80a facing the bottom plate 70 and a second surface 80b located on an opposite side from the first surface 80a. The light reflecting portions 31 and the light scattering portions 32 having a dot pattern are formed on the second surface 80b of the light guide plate 80. The arrangement pattern of the light reflecting portions 31 and the light scattering portions 32 in the light source installation area overlapped portions DA-1 and the empty area overlapping surface DN-1 is same as the second embodiment.

The light reflectance of the second surface 80a of the light guide plate 80 changes along the short-side direction (Y-axis direction) in the entire light guide plate 80, as illustrated in FIGS. 32 and 33. Namely, on the second surface 80a of the light guide plate, the light reflectance of the light source installation area overlapped portion DA-1 is higher than the light reflectance the empty area overlapping surface DN-1. More specifically, on the second surface 80a of the light guide plate 80, the light reflectance is 70% and uniform in the light source installation area overlapped portion DA-1 and it is a maximum value in the light guide plate 80. On the other hand, in the empty area overlapping surface DN-1 of the second surface 80a of the light guide plate 80, the light reflectance decreases in a gradual manner from the portion closer to the light source installation area overlapped portion DA-1 to the portion farther therefrom. The light reflectance is 5% that is a minimum value in the middle portion (center in FIG. 32) of the empty area overlapping surface DN-1 in the short-side direction (Y-axis direction).

As is explained above, according to this embodiment, in the chassis 14 included in the backlight device 12, the bottom plate 70 facing the light guide plate 70 is defined in the first end portion 70A, the second end portion 70B and the middle portion 70C that is sandwiched between the first and second end portions 70A, 70B. The first end portion 70A and the second end portion 70B correspond to the light source installation areas LA-1 where the cold cathode tubes 17 are arranged, and the middle portion 70C corresponds to the empty area LN-1 where no cold cathode tube 17 is arranged. Accordingly, compared to the case in that the cold cathode tubes are evenly installed in the entire chassis, the number of cold cathode tubes 17 is reduced and a cost reduction and power saving of the backlight device 12 are enabled.

Further, in this embodiment, the light source installation area LA-1 is provided in the first end portion 70A and the second end portion 70B of the bottom plate 70, and the light reflectance of the portion of the second surface 80a that overlaps the light source installation area LN-1 (light source installation area overlapped portion DA-1) is higher than the light reflectance of the portion that overlaps the empty area LN-1(empty area overlapping surface DN-1).

According to such a configuration, light emitted from the light source installation areas LA-1 that are provided at the ends of the chassis 14 first reaches the light source installation area overlapped portions DA-1 of the light guide plate 80 that have relatively high light reflectance. Therefore, most of the light is reflected by the light source installation area overlapped portions DA-1. The reflected light reflects off the first surface 80a of the light guide plate 80 or the reflecting sheet 23 to be directed to the empty area overlapping surface DN-1. The light entering the empty area overlapping surface DN-1 is scattered by the light scattering portions 32 and output from a wide area. Therefore, in the empty area overlapping surface DN-1 of the light guide plate 80, the light is directed from two ends thereof and scattered. As a result, it is hardly happened that light is not supplied to the empty area overlapping surface DN-1 and is darkened. Additionally, the light reflectance of the empty area overlapping surface DN-1 is relatively low, and therefore a large amount of light passes therethrough. As a result, the empty area overlapping surface DN-1 (the empty area LN-1) is reliably prevented from being darkened.

### Fourth Embodiment

Next, a fourth embodiment of the present invention will be explained with reference to FIGS. 34 to 36. In the fourth embodiment, the arrangement of the cold cathode tubes and the configuration of the light guide plate are further modified and other configurations are same as the above embodiment. The same parts as the above embodiment are indicated by the same symbols and will not be explained.

FIG. 34 is a plan view illustrating a general construction of cold cathode tubes and a chassis provided in the liquid crystal display device according to the fourth embodiment. FIG. 35 is a plan view illustrating light reflectance of the entire second surface of the light guide plate included in the liquid crystal display device. FIG. 36 is a graph illustrating a reflectivity change in the short-side direction of the light guide plate included in FIG. 35. In FIGS. 34 to 36, the long-side direction of the chassis and the light guide plate is referred to as X-axis direction and the short-side direction thereof is referred to as Y-axis direction. In FIG. 36, a horizontal axis represents the Y-axis direction (short-side direction) and the light reflectance is plotted on a graph from the end closer to the Y1 (Y1 end) to the middle portion and from the middle portion to the end closer to the Y2 (Y2 end) in the Y-axis direction.

A plurality of the cold cathode tubes 17 are arranged in a portion of the chassis 14 such that they are arranged parallel to each other with having a small distance therebetween. More specifically, as illustrated in FIG. 34, a bottom plate 71 of the chassis 14 (a portion facing a light guide plate 81) is defined in the short-side direction in a first end portion 71A, a second end portion 71B that is located at an end opposite from the first end portion 71A and a middle portion 71C that is sandwiched between the first end portion 71A and the second end portion 71B. The cold cathode tubes 17 are arranged in the second end portion 71B of the bottom plate 71 and a light source installation area LA-2 is formed in the second end portion 71B. On the other hand, no cold cathode tube 17 is arranged in the first end portion 71A and the middle portion 71C of the bottom plate 70 and an empty area LN-2 is formed there. Namely, the cold cathode tubes 17 are arranged at one end of the bottom plate 70 of the chassis 14 (the end closer to Y1) to form a light source installation area LA-2.

The light guide plate 81 is provided to face the bottom plate 71 of the chassis 14 and has a portion that overlaps the light source installation area LA-2 (referred to as a light source installation area overlapped portion DA-2) and a portion that overlaps the empty area LN-2 (referred to as an empty area overlapping surface DN-2). The light guide plate 81 has a first surface 81a facing the bottom plate 71 and a second surface 81b that is located on an opposite side from the first surface 81a. The light reflecting portions 31 and the light scattering portions 32 having a dot pattern are formed on the second surface 81b of the light guide plate 81. The arrangement pattern of the light reflecting portions 31 and the light scattering portions 32 in the light source installation area overlapped portion DA-2 and the empty area overlapping surface DN-2 is same as the second embodiment.

The light reflectance of the second surface 81a of the light guide plate 81 changes along the short-side direction (Y-axis direction) as illustrated in FIGS. 35 and 36. Namely, on the second surface 81a of the light guide plate 81, the light reflectance of the light source installation area overlapped portion DA-2 is higher than the light reflectance of the empty area overlapping surface DN-2. More specifically, the light reflectance is 70% and uniform in the light source installation area overlapped portion DA-2 of the second surface 81a of the light guide plate 81 (one end of the light guide plate 81 in the short-side direction, the Y1 end in FIG. 36) and it is a maximum value in the light guide plate 81. On the other hand, in the empty area overlapping surface DN-2 of the second surface 81a of the light guide plate 81, the light reflectance decreases in a continuous and gradual manner from the portion closer to the light source installation area overlapped portion DA-2 toward the portion away therefrom. The light reflectance is 5% that is a minimum value at the other end of the light guide plate 81 (the Y2 end in FIG. 36) in the short-side direction.

As is explained above, according to this embodiment, in the chassis 14 included in the backlight device 12, the bottom plate 71 facing the light guide plate 81 is defined in the first end portion 71A, the second end portion 71B and the middle portion 71C that is sandwiched between the first and second end portions 71A, 71B. The second end portion 71B corresponds to the light source installation areas LA-2 where the cold cathode tubes 17 are arranged, and the first end portion 71A and the middle portion 71C correspond to the empty area LN-2 where no cold cathode tube 17 is arranged. Accordingly, compared to the case in that the cold cathode tubes are evenly installed in the entire chassis, the number of cold cathode tubes 17 is reduced and a cost reduction and power saving of the backlight device 12 are enabled.

Further, in this embodiment, the light source installation area LA-2 is provided in the second end portion 71B of the bottom plate 71, and by providing the light reflecting portions 31 on the second surface 81a, the light reflectance of the portion of the second surface 81a that overlaps the light source installation area LA-2 (light source installation area overlapped portion DA-2) is higher than the light reflectance of the portion that overlaps the empty area LN-2 (empty area overlapping surface DN-2).

According to such a configuration, light emitted from the light source installation area LA-2 first reaches the light source installation area overlapped portion DA-2 of the light guide plate 81 that has relatively high light reflectance and most of the light is reflected by the light source installation area overlapped portion DA-2. The reflected light is further reflected by the first surface 80a of the light guide plate 81 or the reflecting sheet 23 and reaches the empty area overlapping surface DN-2 of the light guide plate 81. The light entering the empty area overlapping surface DN-2 is scattered by the light scattering portions 32 so as to be output from a wide area. The light reflectance of the empty area overlapping surface DN-2 is relatively low, and therefore a larger amount of light passes therethrough and predetermined brightness of the illumination light can be obtained. As a result, the backlight device 12 can achieve uniformity of the illumination brightness. This configuration is especially effective for the backlight device 12 where high brightness is required only at one end of the backlight device.

### Other Embodiments

The embodiments of the present invention have been described, however, the present invention is not limited to the above embodiments explained in the above description and the drawings. The following embodiments may be included in the technical scope of the present invention, for example.

(1) In the above embodiments, the light scattering portions are formed on a surface of the light guide plate facing the optical sheets (a surface opposite from one facing the cold cathode tubes). The configuration of the light scattering portions is not limited thereto. For example, as illustrated in FIG. 37, the light scattering portions 32 may be formed on a first surface of a light guide plate 82 facing the cold cathode tubes. Further, as illustrated in FIG. 38, the light scattering portions 32 may be formed on a first surface and a second surface of a light guide plate 83.

(2) In the above embodiments, the light reflecting portions and the light scattering portions having a dot pattern are formed on the light guide plate, however, the configuration of the light reflecting portions and the light scattering portions is not limited thereto. For example, as illustrated in FIG. 39, a light guide plate 84 having light reflecting portions 310 and light scattering portions 320 of a stripe pattern may be used. In such a case, a distance between the stripes or a width of each stripe may be changed to control the light reflectance and the light scattering intensity of a surface of the light guide plate 84.

(3) In the above embodiments, each dot of the dot pattern of the light reflecting portions and the light scattering portions is formed in a square. However, the shape of each dot is not limited thereto but may be any shape such as a round or a polygonal shape.

(4) In the above embodiments, the light scattering portions are printed on the surface of the light guide plate, however, the light scattering portions may be formed by blasting the surface of the light guide plate to be roughened.

(5) In the above embodiments, the two diffuser sheets are layered as optical sheets on the light output side of the light guide plate. The present invention also includes a configuration in which optical sheets of arbitral combination of a diffuser sheet, a lens sheet and a reflective polarizing plate.

(6) In the above embodiments, the light source installation area is provided at the middle portion or at the ends of the bottom plate of the chassis. However, for example, the light source installation area may be provided at the middle portion and at one end of the bottom plate. Thus, the present invention includes a configuration in that the position of the light source installation area is changed according to the light amount from the cold cathode tubes or conditions of use for the backlight device.

(7) In the above embodiments, the cold cathode tubes are used as the light source, however, other kinds of light source such as a hot cathode tube or LED may be used as the light source.

(8) In the above embodiments, the light reflectance of the light guide plate is designed and controlled by changing an area of each dot of the light reflecting portions. According to the present invention, as control means of the light reflectance, for example, an arrangement distance between adjacent dots each having a same area may be changed or dots having different light reflectance may be formed. Also, according to the present invention, the light scattering intensity of the light guide plate by the light scattering portions may be changed by the above-described means.

1. A lighting device comprising:
at least one light source;
a chassis housing the light source and having an opening for light from the light source to pass through;
an optical member provided so as to face the light source and cover the opening, the optical member being formed of a member having a substantially uniform light reflectance; and
a light reflecting portion formed on a portion of the optical member that overlaps the light source, the light reflecting portion reflecting light from the light source.

2. The lighting device according to claim 1, wherein:
the optical member has a first surface facing the light source and a second surface opposite from the first surface; and
the light reflecting portion is formed on a portion of the second surface that overlaps the light source.

3. The lighting device according to claim 1, further comprising a light scattering portion formed on a portion of the optical member that does not overlap the light source, the light scattering portion scattering the light.

4. The lighting device according to claim 1, wherein:
the light reflecting portion is provided on a portion of the optical member that does not overlap the light source; and
the light reflectance of the second surface of the portion of the optical member that overlaps the light source is higher than the light reflectance of the second surface of the portion of the optical member that does not overlap the light source.

5. The lighting device according to claim 1, wherein the light reflecting portion is provided on the portion of the optical member that does not overlap the light source, and the light reflectance of the second surface decreases in a direction away from the portion that overlaps the light source.

6. The lighting device according to claim 1, wherein the light reflecting portion is formed in a dot pattern having light reflectivity.

7. The lighting device according to claim 6, wherein the dot pattern of the light reflecting portion is configured such that an area of each dot decreases in a direction away from the portion that overlaps the light source.

8. The lighting device according to claim 1, wherein the light scattering portion is formed in a dot pattern having a light scattering property.

9. The lighting device according to claim 8, wherein the dot pattern of the light scattering portion is configured such that an area of each dot increases in a direction away from the portion that overlaps the light source.

10. The lighting device according to claim 1, wherein the light scattering portion is formed on the second surface of the optical member.

11. The lighting device according to claim 1, further comprising a light scattering member provided on a light output side of the optical member, the light scattering member scattering light passing through the optical member.

12. The lighting device according to claim 1, wherein:
the chassis has a surface facing the optical member and including at least a first end portion, a second end portion, and a middle portion, the second end portion being located at an end away from the first end portion, and the middle portion being located between the first end portion and the second end portion;
one or two of the first end portion, the second end portion and the middle portion are configured as light source installation areas in each of which the light source is arranged, and the rest is configured as an empty area in which no light source is arranged.

13. The lighting device according to claim 12, wherein the light source installation area of the chassis is smaller than the empty area.

14. The lighting device according to claim 12, wherein the light source installation area is provided in the middle portion of the chassis.

15. The lighting device according to claim 12, wherein the light source installation area is provided in one of the first end portion and the second end portion.

16. The lighting device according to claim 12, wherein the light source installation area is provided in each of the first end portion and the second end portion.

17. The lighting device according to claim 12, wherein the light reflectance of at least the second surface of the portion that overlaps the empty area is higher on a side close to the portion that overlaps the light source installation area than on a side away therefrom.

18. The lighting device according to claim 12, wherein the chassis includes a light reflecting member in the empty area, the light reflecting member having a directing surface for directing light from the light source to the optical member.

19. The lighting device according to claim 12, further comprising a light source driving board configured to supply driving power to the light source, wherein the light source driving board is disposed so as to overlap the light source installation area.

20. The lighting device according to claim 1, further comprising at least one heat transfer member disposed between the light source and the chassis for transferring heat therebetween.

21. The lighting device according to claim 20, wherein:
the at least one light source including a plurality of light sources is disposed such that the light sources are arranged in parallel to each other; and
the at least one heat transfer member including a plurality of heat transfer members is disposed between the light sources and the chassis such that one heat transfer member and the heat transfer members adjacent to the one heat transfer member are offset from each other in an alignment direction of the light sources.

22. A display device comprising:
the lighting device according to claim 1; and
a display panel configured to provide display using light from the lighting device for a display device.

23. The display device according to claim 22, wherein the display panel is a liquid crystal display panel using liquid crystal.

24. A television receiver comprising the display device according to claim 22.
